(19) United States
(12) Patent Application Publication
(10) Pub. No.: US 2026/0105838 A1
(43) Pub. Date: Apr. 16, 2026

(54) SYSTEMS AND TECHNIQUES FOR AUTONOMOUSLY SENSING, MONITORING, AND CONTROLLING VEHICLES USING OVERHEAD SENSOR SYSTEM MODULES

(71) Applicant: Stuart Alexander Jacobson, Beaverton, OR (US)

(72) Inventor: Stuart Alexander Jacobson, Beaverton, OR (US)

(21) Appl. No.: 19/115,746

(22) PCT Filed: Oct. 16, 2023
(86) PCT No.: PCT/US2023/076976

§ 371 Date: Mar. 26, 2025

Related U.S. Application Data
(60) Provisional application No. 63/379,860, filed on Oct. 17, 2022.
(60) Provisional application No. 63/380,358, filed on Oct. 20, 2022.

(51) Int. Cl. G08G 1/0967; B60W 10/04; B60W 10/20; B60W 60/00; G08G 1/01

(52) U.S. Cl. CPC G08G 1/096725; B60W 10/04; B60W 10/20; B60W 60/001; G08G 1/0116; G08G 1/0129; G08G 1/0133; G08G 1/096783; B60W 2554/4029; B60W 2555/60; B60W 2556/45; B60W 2710/20; B60W 2720/106

(57) ABSTRACT

A process can include obtaining sensor data associated with one or more field of view (FOV) coverage areas of a roadway environment, wherein the sensor data includes respective sensor streams obtained from a plurality of distributed sensors deployed on roadside infrastructure within the roadway environment, each sensor corresponding to a particular FOV coverage area. The sensor data can be transmitted to a vehicle traffic analysis engine configured to identify sensor data obtained from different sensors and different FOV coverage areas as corresponding to a same first vehicle. The vehicle traffic analysis engine can analyze the identified sensor data to determine one or more driving characteristics of the first vehicle within the roadway environment. Driver assistance information can be transmitted to the first vehicle, wherein the driver assistance information is configured to remediate erratic driving characteristics included in the determined one or more driving characteristics of the first vehicle.

### CROSS-REFERENCE TO RELATED APPLICATIONS

This application claims the benefit of priority to U.S. Provisional Ser. No. 63/379,860 filed Oct. 17, 2022 and entitled “SYSTEMS AND TECHNIQUES FOR AUTONOMOUSLY SENSING, MONITORING, AND CONTROLLING VEHICLES USING OVERHEAD SENSOR SYSTEM MODULES,” and U.S. Provisional Ser. No. 63/380,358 filed Oct. 20, 2022 and entitled “SYSTEMS AND TECHNIQUES FOR AUTONOMOUSLY SENSING, MONITORING, AND CONTROLLING VEHICLES USING OVERHEAD SENSOR SYSTEM MODULES,” the disclosure of which is each herein incorporated by reference in its entirety and for all purposes.

### TECHNICAL FIELD

The present disclosure relates generally to vehicle navigation and control, and more particularly pertains to distributed sensing performed external to a vehicle.

### BACKGROUND

An autonomous vehicle is a motorized vehicle that can navigate without a human driver. Different levels of autonomous vehicle control can be provided. For example, a semi-autonomous vehicle may include one or more automated systems to perform steering and/or acceleration in certain scenarios. A fully autonomous vehicle can perform all driving tasks, although human override may remain available. An exemplary autonomous vehicle includes a plurality of sensor systems, such as, but not limited to, a camera sensor system, a Lighting Detection and Ranging (LIDAR) sensor system, a radar sensor system, amongst others, wherein the autonomous vehicle operates based upon sensor signals output by the sensor systems. Specifically, the sensor signals are provided to an internal computing system in communication with the plurality of sensor systems, wherein a processor executes instructions based upon the sensor signals to control a mechanical system of the autonomous vehicle, such as a vehicle propulsion system, a braking system, or a steering system.

Advanced Driver Assistance Systems (ADAS) levels can be used to classify the autonomy systems of vehicles based on their respective capabilities. ADAS levels can refer to the set of six levels (0 to 5) defined by the Society of Automotive Engineers (SAE), or may be used more generally to refer to different levels and/or extents of autonomy. The six ADAS levels categorized by the SAE include Level 0 (No Automation), Level 1 (Driver Assistance), Level 2 (Partial Automation), Level 3 (Conditional Automation), Level 4 (High-Level Automation), and Level 5 (Full Automation).

### BRIEF SUMMARY

According to at least one illustrative example, a method is provided, the method comprising: obtaining sensor data associated with one or more field of view (FOV) coverage areas of a roadway environment, wherein the sensor data includes respective sensor streams obtained from a plurality of distributed sensors deployed on roadside infrastructure within the roadway environment, each sensor of the plurality of distributed sensors corresponding to a particular one of the one or more FOV coverage areas; transmitting at least a portion of the sensor data to a vehicle traffic analysis engine, wherein the vehicle traffic analysis engine is configured to identify sensor data obtained from different sensors and different FOV coverage areas as corresponding to a same first vehicle; analyzing, by the vehicle traffic analysis engine, the identified sensor data to determine one or more driving characteristics of the first vehicle within the roadway environment; and transmitting, to the first vehicle, automatically generated driver assistance information, wherein the automatically generated driver assistance information is configured to remediate erratic driving characteristics included in the determined one or more driving characteristics of the first vehicle.

In some aspects, the techniques described herein relate to a method, wherein the determined one or more driving characteristics of the first vehicle are based on analyzing the identified sensor data against one or more traffic safety rules.

In some aspects, the techniques described herein relate to a method, further including identifying the erratic driving characteristics as a deviation from a baseline of expected driving characteristics observed by the vehicle traffic analysis engine for historic vehicle traffic within the one or more FOV coverage areas of the roadway environment.

In some aspects, the techniques described herein relate to a method, wherein the automatically generated driver assistance information includes control or configuration information generated for an Advanced Driver Assistance Systems (ADAS) control module of the first vehicle.

In some aspects, the techniques described herein relate to a method, wherein the control or configuration information corresponds to a configured ADAS level for the first vehicle.

In some aspects, the techniques described herein relate to a method, wherein the automatically generated driver assistance information includes a notification message to an infotainment system or onboard display of the first vehicle.

In some aspects, the techniques described herein relate to a method, wherein the notification message includes an ADAS level 0 control or configuration information.

In some aspects, the techniques described herein relate to a method, further including: analyzing the obtained sensor data using one or more trained machine learning networks, wherein the one or more trained machine learning networks generate as output one or more detected objects of interest and movement information associated with the one or more detected objects of interest; and based on analyzing the obtained sensor data, automatically generating one or more autonomous vehicle control commands.

In some aspects, the techniques described herein relate to a method, wherein the detected objects of interest include one or more of a vehicle, a pedestrian, and a moving object located in the roadway environment.

In some aspects, the techniques described herein relate to a method, wherein the one or more autonomous vehicle control commands are transmitted to a receiver coupled to a control system of a vehicle located within the FOV coverage area of the roadway environment.

In some aspects, the techniques described herein relate to a method, wherein the one or more autonomous vehicle control commands are configured to halt movement of the vehicle in response to determining that movement information associated with the vehicle violates one or more pre-determined traffic rules.

In some aspects, the techniques described herein relate to a method, wherein the one or more autonomous vehicle control commands are configured to autonomously navigate the vehicle within the FOV coverage area by automatically controlling acceleration and steering of the vehicle.

In some aspects, the techniques described herein relate to a method, wherein the sensor data is obtained from one or more overhead sensor system modules installed on a light pole, traffic light, or other infrastructure element located above the roadway environment.

In some aspects, the techniques described herein relate to a method, wherein the FOV coverage area corresponds to an FOV of a single overhead sensor system module.

In some aspects, the techniques described herein relate to a method, wherein the FOV coverage area is a combined FOV generated using a respective FOV associated with each overhead sensor system module of a plurality of overhead sensor system modules.

In another illustrative example, an apparatus is provided, where the apparatus comprises at least one memory and at least one processor coupled to the at least one memory, the at least one processor configured to: obtain sensor data associated with one or more field of view (FOV) coverage areas of a roadway environment, wherein the sensor data includes respective sensor streams obtained from a plurality of distributed sensors deployed on roadside infrastructure within the roadway environment, each sensor of the plurality of distributed sensors corresponding to a particular one of the one or more FOV coverage areas; transmit at least a portion of the sensor data to a vehicle traffic analysis engine, wherein the vehicle traffic analysis engine is configured to identify sensor data obtained from different sensors and different FOV coverage areas as corresponding to a same first vehicle; analyze, by the vehicle traffic analysis engine, the identified sensor data to determine one or more driving characteristics of the first vehicle within the roadway environment; and transmit, to the first vehicle, automatically generated driver assistance information, wherein the automatically generated driver assistance information is configured to remediate erratic driving characteristics included in the determined one or more driving characteristics of the first vehicle.

In some aspects, the techniques described herein relate to an apparatus, wherein, to determine the determined one or more driving characteristics of the first vehicle, the at least one processor is configured to analyze the identified sensor data against one or more traffic safety rules.

In some aspects, the techniques described herein relate to an apparatus, wherein the at least one processor is further configured to identify the erratic driving characteristics as a deviation from a baseline of expected driving characteristics observed by the vehicle traffic analysis engine for historic vehicle traffic within the one or more FOV coverage areas of the roadway environment.

In some aspects, the techniques described herein relate to an apparatus, wherein the automatically generated driver assistance information includes control or configuration information generated for an Advanced Driver Assistance Systems (ADAS) control module of the first vehicle.

In some aspects, the techniques described herein relate to an apparatus, wherein the control or configuration information corresponds to a configured ADAS level for the first vehicle.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 is a diagram illustrating an example wireless communications system, in accordance with some examples;

FIG. 2 is a block diagram illustrating an example of a computing system of a vehicle, in accordance with some examples;

FIG. 3 is a block diagram illustrating an example of a computing system of a user device, in accordance with some examples;

FIG. 4 is a diagram illustrating an example road intelligence network deployment scenario that can be configured to monitor vehicle activity on a roadway and/or generate driver assistance information, in accordance with some examples;

FIG. 5 is a diagram illustrating an example road intelligence network deployment scenario that can be configured to monitor vehicle activity on a roadway and/or generate traffic safety notifications, in accordance with some examples; and

FIG. 6 is a block diagram illustrating an example of a computing system, in accordance with some examples.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without departing from the spirit and scope of the disclosure. Additional features and advantages of the disclosure will be set forth in the description which follows, and in part will be obvious from the description, or can be learned by practice of the herein disclosed principles. It will be appreciated that for simplicity and clarity of illustration, where appropriate, reference numerals have been repeated among the different figures to indicate corresponding or analogous elements. The description is not to be considered as limiting the scope of the embodiments described herein.

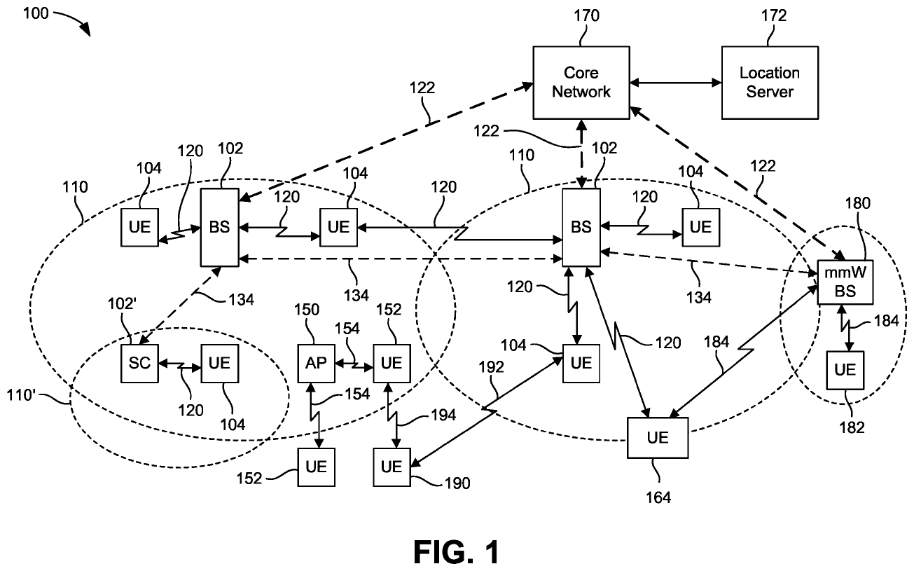

FIG. 1 illustrates an exemplary wireless communications system 100. The wireless communications system 100 (which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally or alternatively, one or more of the base stations 102 can be implemented in a disaggregated base station architecture, and may include one or more of a central unit (CU), a distributed unit (DU), a radio unit (RU), etc. The base stations 102 can include macro cell base stations (high power cellular base stations) and/or small cell base stations (low power cellular base stations). The macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′may have a coverage area 110′that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG). The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc. utilizing the ultra-wideband (UWB) spectrum, ranging from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum, with a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHZ and 30 GHZ, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node or entity (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while canceling to suppress radiation in undesired directions.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

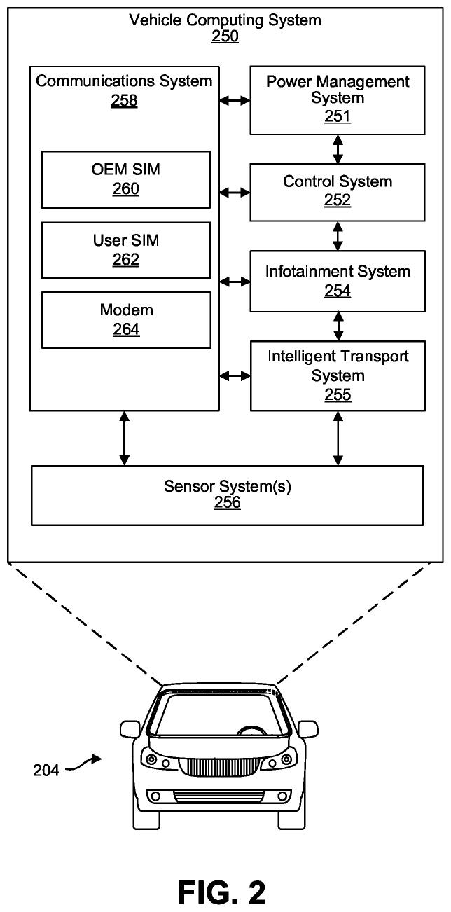

FIG. 2 is a block diagram illustrating an example a vehicle computing system 250 of a vehicle 204. The vehicle 204 is an example of a UE that can communicate with a network (e.g., an eNB, a gNB, a positioning beacon, a location measurement unit, and/or other network entity) over a Uu interface and with other UEs using V2X communications over a PC5 interface (or other device to device direct interface, such as a DSRC interface), etc. As shown, the vehicle computing system 250 can include at least a power management system 251, a control system 252, an infotainment system 254, an intelligent transport system (ITS) 255, one or more sensor systems 256, and a communications system 258. In some cases, the vehicle computing system 250 can include or can be implemented using any type of processing device or system, such as one or more central processing units (CPUs), digital signal processors (DSPs), application specific integrated circuits (ASICs), field programmable gate arrays (FPGAs), application processors (APs), graphics processing units (GPUs), vision processing units (VPUs), Neural Network Signal Processors (NSPs), microcontrollers, dedicated hardware, any combination thereof, and/or other processing device or system.

The control system 252 can be configured to control one or more operations of the vehicle 204, the power management system 251, the computing system 250, the infotainment system 254, the ITS 255, and/or one or more other systems of the vehicle 204 (e.g., a braking system, a steering system, a safety system other than the ITS 255, a cabin system, and/or other system). In some examples, the control system 252 can include one or more electronic control units (ECUs). An ECU can control one or more of the electrical systems or subsystems in a vehicle. Examples of specific ECUs that can be included as part of the control system 252 include an engine control module (ECM), a powertrain control module (PCM), a transmission control module (TCM), a brake control module (BCM), a central control module (CCM), a central timing module (CTM), among others. In some cases, the control system 252 can receive sensor signals from the one or more sensor systems 256 and can communicate with other systems of the vehicle computing system 250 to operate the vehicle 204.

In one illustrative example, the control system 252 can include or otherwise integrate/communicate with an ADAS system associated with the vehicle 204.

The vehicle computing system 250 also includes a power management system 251. In some implementations, the power management system 251 can include a power management integrated circuit (PMIC), a standby battery, and/or other components. In some cases, other systems of the vehicle computing system 250 can include one or more PMICs, batteries, and/or other components. The power management system 251 can perform power management functions for the vehicle 204, such as managing a power supply for the computing system 250 and/or other parts of the vehicle. For example, the power management system 251 can provide a stable power supply in view of power fluctuations, such as based on starting an engine of the vehicle. In another example, the power management system 251 can perform thermal monitoring operations, such as by checking ambient and/or transistor junction temperatures. In another example, the power management system 251 can perform certain functions based on detecting a certain temperature level, such as causing a cooling system (e.g., one or more fans, an air conditioning system, etc.) to cool certain components of the vehicle computing system 250 (e.g., the control system 252, such as one or more ECUs), shutting down certain functionalities of the vehicle computing system 250 (e.g., limiting the infotainment system 254, such as by shutting off one or more displays, disconnecting from a wireless network, etc.), among other functions.

The vehicle computing system 250 further includes a communications system 258. The communications system 258 can include both software and hardware components for transmitting signals to and receiving signals from a network (e.g., a gNB or other network entity over a Uu interface) and/or from other UEs (e.g., to another vehicle or UE over a PC5 interface, WiFi interface (e.g., DSRC), Bluetooth™ interface, and/or other wireless and/or wired interface). For example, the communications system 258 is configured to transmit and receive information wirelessly over any suitable wireless network (e.g., a 3G network, 2G network, 3G network, WiFi network, Bluetooth™ network, and/or other network). The communications system 258 includes various components or devices used to perform the wireless communication functionalities, including an original equipment manufacturer (OEM) subscriber identity module (referred to as a SIM or SIM card) 260, a user SIM 262, and a modem 264. While the vehicle computing system 250 is shown as having two SIMs and one modem, the computing system 250 can have any number of SIMs (e.g., one SIM or more than two SIMs) and any number of modems (e.g., one modem, two modems, or more than two modems) in some implementations.

A SIM is a device (e.g., an integrated circuit) that can securely store an international mobile subscriber identity (IMSI) number and a related key (e.g., an encryption-decryption key) of a particular subscriber or user. The IMSI and key can be used to identify and authenticate the subscriber on a particular UE. The OEM SIM 260 can be used by the communications system 258 for establishing a wireless connection for vehicle-based operations, such as for conducting emergency-calling (eCall) functions, communicating with a communications system of the vehicle manufacturer (e.g., for software updates, etc.), among other operations. The OEM SIM 260 can be important for the OEM SIM to support critical services, such as eCall for making emergency calls in the event of a car accident or other emergency. For instance, eCall can include a service that automatically dials an emergency number (e.g., “9-1-1” in the United States, “1-1-2” in Europe, etc.) in the event of a vehicle accident and communicates a location of the vehicle to the emergency services, such as a police department, fire department, etc.

The user SIM 262 can be used by the communications system 258 for performing wireless network access functions in order to support a user data connection (e.g., for conducting phone calls, messaging, Infotainment related services, among others). In some cases, a user device of a user can connect with the vehicle computing system 250 over an interface (e.g., over PC5, Bluetooth™, WiFi™ (e.g., DSRC), a universal serial bus (USB) port, and/or other wireless or wired interface). Once connected, the user device can transfer wireless network access functionality from the user device to communications system 258 the vehicle, in which case the user device can cease performance of the wireless network access functionality (e.g., during the period in which the communications system 258 is performing the wireless access functionality). The communications system 258 can begin interacting with a base station to perform one or more wireless communication operations, such as facilitating a phone call, transmitting and/or receiving data (e.g., messaging, video, audio, etc.), among other operations. In such cases, other components of the vehicle computing system 250 can be used to output data received by the communications system 258. For example, the infotainment system 254 (described below) can display video received by the communications system 258 on one or more displays and/or can output audio received by the communications system 258 using one or more speakers.

A modem is a device that modulates one or more carrier wave signals to encode digital information for transmission, and demodulates signals to decode the transmitted information. The modem 264 (and/or one or more other modems of the communications system 258) can be used for communication of data for the OEM SIM 260 and/or the user SIM 262. In some examples, the modem 264 can include a 2G (or LTE) modem and another modem (not shown) of the communications system 258 can include a 3G (or NR) modem. In some examples, the communications system 258 can include one or more Bluetooth™ modems (e.g., for Bluetooth™ Low Energy (BLE) or other type of Bluetooth communications), one or more WiFi™ modems (e.g., for DSRC communications and/or other WiFi communications), wideband modems (e.g., an ultra-wideband (UWB) modem), any combination thereof, and/or other types of modems.

In some cases, the modem 264 (and/or one or more other modems of the communications system 258) can be used for performing V2X communications (e.g., with other vehicles for V2V communications, with other devices for D2D communications, with infrastructure systems for V2I communications, with pedestrian UEs for V2P communications, etc.). In some examples, the communications system 258 can include a V2X modem used for performing V2X communications (e.g., sidelink communications over a PC5 interface or DSRC interface), in which case the V2X modem can be separate from one or more modems used for wireless network access functions (e.g., for network communications over a network/Uu interface and/or sidelink communications other than V2X communications).

In some examples, the communications system 258 can be or can include a telematics control unit (TCU). In some implementations, the TCU can include a network access device (NAD) (also referred to in some cases as a network control unit or NCU). The NAD can include the modem 264, any other modem not shown in FIG. 2, the OEM SIM 260, the user SIM 262, and/or other components used for wireless communications. In some examples, the communications system 258 can include a Global Navigation Satellite System (GNSS). In some cases, the GNSS can be part of the one or more sensor systems 256, as described below. The GNSS can provide the ability for the vehicle computing system 250 to perform one or more location services, navigation services, and/or other services that can utilize GNSS functionality.

In some cases, the communications system 258 can further include one or more wireless interfaces (e.g., including one or more transceivers and one or more baseband processors for each wireless interface) for transmitting and receiving wireless communications, one or more wired interfaces (e.g., a serial interface such as a universal serial bus (USB) input, a lightening connector, and/or other wired interface) for performing communications over one or more hardwired connections, and/or other components that can allow the vehicle 204 to communicate with a network and/or other UEs.

The vehicle computing system 250 can also include an infotainment system 254 that can control content and one or more output devices of the vehicle 204 that can be used to output the content. The infotainment system 254 can also be referred to as an in-vehicle infotainment (IVI) system or an In-car entertainment (ICE) system. The content can include navigation content, media content (e.g., video content, music or other audio content, and/or other media content), among other content. The one or more output devices can include one or more graphical user interfaces, one or more displays, one or more speakers, one or more extended reality devices (e.g., a VR, AR, and/or MR headset), one or more haptic feedback devices (e.g., one or more devices configured to vibrate a seat, steering wheel, and/or other part of the vehicle 204), and/or other output device.

In some examples, the computing system 250 can include the intelligent transport system (ITS) 255. In some examples, the ITS 255 can be used for implementing V2X communications. For example, an ITS stack of the ITS 255 can generate V2X messages based on information from an application layer of the ITS. In some cases, the application layer can determine whether certain conditions have been met for generating messages for use by the ITS 255 and/or for generating messages that are to be sent to other vehicles (for V2V communications), to pedestrian UEs (for V2P communications), and/or to infrastructure systems (for V2I communications). In some cases, the communications system 258 and/or the ITS 255 can obtain car access network (CAN) information (e.g., from other components of the vehicle via a CAN bus). In some examples, the communications system 258 (e.g., a TCU NAD) can obtain the CAN information via the CAN bus and can send the CAN information to a PHY/MAC layer of the ITS 255. The ITS 255 can provide the CAN information to the ITS stack of the ITS 255. The CAN information can include vehicle related information, such as a heading of the vehicle, speed of the vehicle, breaking information, among other information. The CAN information can be continuously or periodically (e.g., every 1 millisecond (ms), every 10 ms, or the like) provided to the ITS 255.

The conditions used to determine whether to generate messages can be determined using the CAN information based on safety-related applications and/or other applications, including applications related to road safety, traffic efficiency, infotainment, business, and/or other applications. In one illustrative example, the ITS 255 can perform lane change assistance or negotiation. For instance, using the CAN information, the ITS 255 can determine that a driver of the vehicle 204 is attempting to change lanes from a current lane to an adjacent lane (e.g., based on a blinker being activated, based on the user veering or steering into an adjacent lane, etc.). Based on determining the vehicle 204 is attempting to change lanes, the ITS 255 can determine a lane-change condition has been met that is associated with a message to be sent to other vehicles that are nearby the vehicle in the adjacent lane. The ITS 255 can trigger the ITS stack to generate one or more messages for transmission to the other vehicles, which can be used to negotiate a lane change with the other vehicles. Other examples of applications include forward collision warning, automatic emergency breaking, lane departure warning, pedestrian avoidance or protection (e.g., when a pedestrian is detected near the vehicle 204, such as based on V2P communications with a UE of the user), traffic sign recognition, among others. The ITS 255 can use any suitable protocol to generate messages (e.g., V2X messages). Examples of protocols that can be used by the ITS 255 include one or more Society of Automotive Engineering (SAE) standards, such as SAE J2735, SAE J2945, SAE J3161, and/or other standards, which are hereby incorporated by reference in their entirety and for all purposes.

In some examples, the ITS 255 can determine certain operations (e.g., V2X-based operations) to perform based on messages received from other UEs. The operations can include safety-related and/or other operations, such as operations for road safety, traffic efficiency, infotainment, business, and/or other applications. In some examples, the operations can include causing the vehicle (e.g., the control system 252) to perform automatic functions, such as automatic breaking, automatic steering (e.g., to maintain a heading in a particular lane), automatic lane change negotiation with other vehicles, among other automatic functions. In one illustrative example, a message can be received by the communications system 258 from another vehicle (e.g., over a PC5 interface, a DSRC interface, or other device to device direct interface) indicating that the other vehicle is coming to a sudden stop. In response to receiving the message, the ITS stack can generate a message or instruction and can send the message or instruction to the control system 252, which can cause the control system 252 to automatically break the vehicle 204 so that it comes to a stop before making impact with the other vehicle. In other illustrative examples, the operations can include triggering display of a message alerting a driver that another vehicle is in the lane next to the vehicle, a message alerting the driver to stop the vehicle, a message alerting the driver that a pedestrian is in an upcoming cross-walk, a message alerting the driver that a toll booth is within a certain distance (e.g., within 1 mile) of the vehicle, among others.

In some examples, the ITS 255 can receive a large number of messages from the other UEs (e.g., vehicles, RSUs, etc.), in which case the ITS 255 will authenticate (e.g., decode and decrypt) each of the messages and/or determine which operations to perform. Such a large number of messages can lead to a large computational load for the vehicle computing system 250. In some cases, the large computational load can cause a temperature of the computing system 250 to increase. Rising temperatures of the components of the computing system 250 can adversely affect the ability of the computing system 250 to process the large number of incoming messages. One or more functionalities can be transitioned from the vehicle 204 to another device (e.g., a user device, a RSU, etc.) based on a temperature of the vehicle computing system 250 (or component thereof) exceeding or approaching one or more thermal levels. Transitioning the one or more functionalities can reduce the computational load on the vehicle 204, helping to reduce the temperature of the components. A thermal load balancer can be provided that enable the vehicle computing system 250 to perform thermal based load balancing to control a processing load depending on the temperature of the computing system 250 and processing capacity of the vehicle computing system 250.

The computing system 250 further includes one or more sensor systems 256 (e.g., a first sensor system through an Nth sensor system, where N is a value equal to or greater than 0). When including multiple sensor systems, the sensor system(s) 256 can include different types of sensor systems that can be arranged on or in different parts the vehicle 204. The sensor system(s) 256 can include one or more camera sensor systems, LIDAR sensor systems, radio detection and ranging (RADAR) sensor systems, Electromagnetic Detection and Ranging (EmDAR) sensor systems, Sound Navigation and Ranging (SONAR) sensor systems, Sound Detection and Ranging (SODAR) sensor systems, Global Navigation Satellite System (GNSS) receiver systems (e.g., one or more Global Positioning System (GPS) receiver systems), accelerometers, gyroscopes, inertial measurement units (IMUs), infrared sensor systems, laser rangefinder systems, ultrasonic sensor systems, infrasonic sensor systems, microphones, any combination thereof, and/or other sensor systems. It should be understood that any number of sensors or sensor systems can be included as part of the computing system 250 of the vehicle 204.

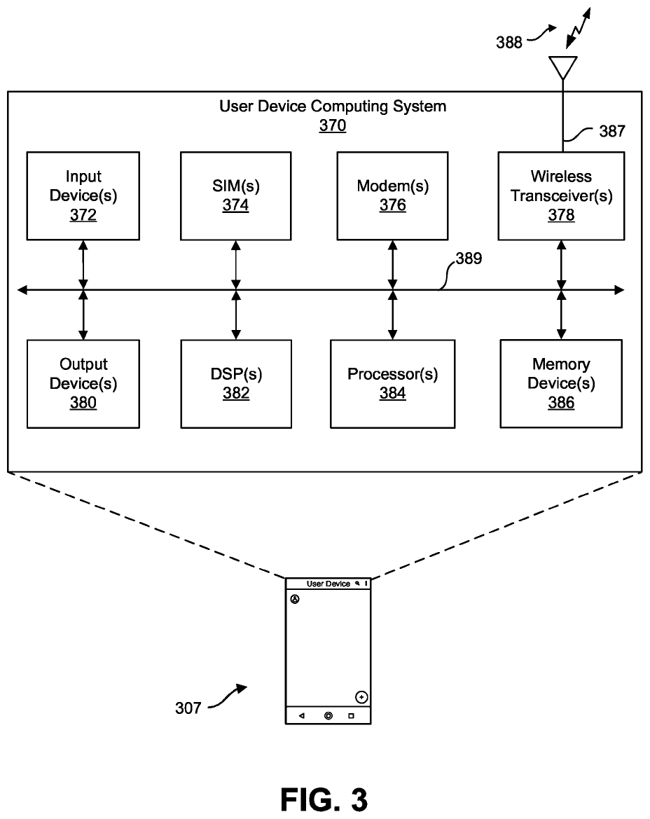

FIG. 3 illustrates an example of a computing system 370 of a user device 307 (or UE). The user device 307 is an example of a UE that can be used by an end-user. For example, the user device 307 can include a mobile phone, router, tablet computer, laptop computer, tracking device, a network-connected wearable device (e.g., a smart watch, glasses, an XR device, etc.), Internet of Things (IoT) device, and/or other device used by a user to communicate over a wireless communications network. The computing system 370 includes software and hardware components that can be electrically or communicatively coupled via a bus 389 (or may otherwise be in communication, as appropriate). For example, the computing system 370 includes one or more processors 384. The one or more processors 384 can include one or more CPUs, ASICs, FPGAS, APs, GPUs, VPUs, NSPs, microcontrollers, dedicated hardware, any combination thereof, and/or other processing device or system. The bus 389 can be used by the one or more processors 384 to communicate between cores and/or with the one or more memory devices 386.

The computing system 370 may also include one or more memory devices 386, one or more digital signal processors (DSPs) 382, one or more SIMs 374, one or more modems 376, one or more wireless transceivers 378, an antenna 387, one or more input devices 372 (e.g., a camera, a mouse, a keyboard, a touch sensitive screen, a touch pad, a keypad, a microphone, and/or the like), and one or more output devices 380 (e.g., a display, a speaker, a printer, and/or the like).

The one or more wireless transceivers 378 can receive wireless signals (e.g., signal 388) via antenna 387 from one or more other devices, such as other user devices, vehicles (e.g., vehicle 204 of FIG. 2 described above), network devices (e.g., base stations such as eNBs and/or gNBs, WiFi routers, etc.), cloud networks, and/or the like. In some examples, the computing system 370 can include multiple antennae. The wireless signal 388 may be transmitted via a wireless network. The wireless network may be any wireless network, such as a cellular or telecommunications network (e.g., 3G, 2G, 3G, etc.), wireless local area network (e.g., a WiFi network), a Bluetooth™M network, and/or other network. In some examples, the one or more wireless transceivers 378 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can handle selection and conversion of the wireless signals 388 into a baseband or intermediate frequency and can convert the RF signals to the digital domain.

The one or more SIMs 374 can each securely store an IMSI number and related key assigned to the user of the user device 307. As noted above, the IMSI and key can be used to identify and authenticate the subscriber when accessing a network provided by a network service provider or operator associated with the one or more SIMs 374. The one or more modems 376 can modulate one or more signals to encode information for transmission using the one or more wireless transceivers 378. The one or more modems 376 can also demodulate signals received by the one or more wireless transceivers 378 in order to decode the transmitted information. In some examples, the one or more modems 376 can include a 2G (or LTE) modem, a 3G (or NR) modem, a modem configured for V2X communications, and/or other types of modems. The one or more modems 376 and the one or more wireless transceivers 378 can be used for communicating data for the one or more SIMs 374.

The computing system 370 can also include (and/or be in communication with) one or more non-transitory machine-readable storage media or storage devices (e.g., one or more memory devices 386), which can include, without limitation, local and/or network accessible storage, a disk drive, a drive array, an optical storage device, a solid-state storage device such as a RAM and/or a ROM, which can be programmable, flash-updateable and/or the like. Such storage devices may be configured to implement any appropriate data storage, including without limitation, various file systems, database structures, and/or the like. In various aspects, functions may be stored as one or more computer-program products (e.g., instructions or code) in memory device(s) 386 and executed by the one or more processor(s) 384 and/or the one or more DSPs 382. The computing system 370 can also include software elements (e.g., located within the one or more memory devices 386), including, for example, an operating system, device drivers, executable libraries, and/or other code, such as one or more application programs, which may comprise computer programs implementing the functions provided by various aspects, and/or may be designed to implement methods and/or configure systems, as described herein.

Autonomous vehicle (AV) navigation can be dependent on the ability of the AV to detect and make sense of its surrounding environment. As used herein, an “autonomous vehicle” or “AV” can refer to a vehicle or movable transportation apparatus having various different types or modalities of autonomy levels, autonomy systems, autonomy configurations, etc. Additionally, it is noted that while reference is made to terrestrial vehicles (e.g., such as cars, and other wheel-based vehicles or forms of transportation) in the examples described herein, the term “vehicle” may be used to refer to any mobile apparatus designed for transport, whether autonomously or by external control, that is capable of movement on and/or above terrestrial surfaces. For instance, a “vehicle” can refer to a car, automobile, or other wheeled form of transportation, and/or may additionally refer to aerial or flying forms of transportation (e.g., including, but not limited to, drones, unmanned aerial vehicles (UAVs), unmanned aircraft systems (UASs), aircraft, airplanes, etc.) In the illustrative examples presented herein, an AV can refer to a vehicle that implements any combination of automation and human control/intervention for dynamic driving activities of the vehicle. In some aspects, an AV can refer to a vehicle that corresponds to any one of the six ADAS levels categorized by the SAE, which are summarized below:
Level 0 (No Automation): No automated vehicle control actions. All tasks are performed by the human driver, although warnings or assistive information can be issued by the ADAS system.
Level 1 (Driver Assistance): Single-task automation. For example, adaptive cruise control, lane following, etc. The human driver is responsible for all other aspects of driving, including monitoring the environment.
Level 2 (Partial Automation): Multiple-task automation, such as steering and acceleration, but the human driver is required to remain engaged and to monitor the environment at all times.
Level 3 (Conditional Automation): The vehicle itself is able to handle all major aspects of driving within specified conditions or operational design domains. Human intervention may be required when the conditions are no longer met, which can occur abruptly, and the driver must be available to take over.
Level 4 (High-Level Automation): The vehicle can handle all aspects of driving within its operational design domain, even if human intervention is needed, and the vehicle is able to safely come to a stop autonomously if the driver fails to respond.
Level 5 (Full Automation): Steering wheel, pedals, other human input or control components are not needed. The vehicle is capable of all driving tasks under all conditions and environments.

In some implementations, the various navigation functions associated with an AV (e.g., the various autonomous or semi-autonomous actions, functions, etc., that can be performed by an AV and/or an ADAS system of a vehicle) are performed based on using labeled images or other mapping data that correspond to an environment through which an AV is navigating. For example, properly labeled images indicating drivable surfaces (e.g., roadways, intersections, crosswalks, and on-ramps, etc.) can be used by an AV to make navigation and planning decisions. If an AV does not have properly labeled images, or does not have labeled images at all, it can be challenging for the AV to correctly and safely make navigation and planning decisions. If the labeled images or mapping data available to the AV are incomplete or not properly updated, the AV may not be able to detect traffic control objects such as stop signs, speed bumps, crosswalks, etc. Labeled images can be generated manually (e.g., by human labelers or annotators who view an image or images and provide one or more pieces of corresponding label information for the image(s)), can be generated automatically, and/or can be generated using any combination of the manual and automatic approaches.

In many existing approaches to AV navigation, a plurality of sensor systems are provided onboard the AV, with the collected sensor data processed partially (or fully) onboard the AV to make navigation and planning decisions for controlling the AV as it drives through its surrounding environment. The sensor systems utilized onboard AVs are often complex and adapted to the specific use case and/or control system design implemented by a given AV. For example, as mentioned previously, existing AVs can utilize plurality of sensor systems, which may include, but are not limited to, a camera sensor system, a Lighting Detection and Ranging (LIDAR) sensor system, a radar sensor system, amongst others, wherein the AV operates based upon sensor signals output by the sensor systems. As such, current AV implementations can be expensive to implement, as AVs with local (e.g., onboard) sensing and control capabilities may require customized hardware that cannot be easily retrofit (if at all) onto existing or legacy vehicles. Accordingly, there is a need for systems and techniques that can be used to implement autonomous vehicle control without the need for onboard sensing capabilities at the vehicle. There is a further need for systems and techniques that can be used to provide autonomous vehicle control for legacy vehicles with minimal hardware modification required.

For example, the systems and techniques described herein can be used to offload some (or all) of the sensing capability associated with AV control and/or vehicle assistance information from being captured onboard the vehicle to being captured at one or more locations external to (e.g., separate and/or remote from) the vehicle. In one illustrative example, the sensor information can be obtained from a road intelligence network or other sensor infrastructure that is provided adjacent to or otherwise nearby to one or more road surfaces where vehicles will travel or are anticipated to be traveling. For instance, as will be described in greater depth below, existing road and highway infrastructure can be extended or augmented to include road intelligence sensor and/or communication network infrastructure. In some embodiments, a plurality of sensors (e.g., including but not limited to: cameras and other imaging devices, thermal cameras, radars, lidars, pressure sensors or various other physical parameter sensors, etc.) can be deployed to various roadway locations and used to capture respective views of and/or information associated with the roadway and one or more vehicles traveling thereon.

As used herein, the various roadway locations to which the one or more sensors of the road intelligence network infrastructure can be deployed may refer to fixed or static locations, as well as movable or dynamic locations. For instance, a first subset of a plurality of roadway sensor locations may comprise static deployment locations where sensors are mounted on poles, signage, bridges or overpasses, adjacent building structures, power poles, telecommunications or cellular towers, etc. The static deployment locations can be provided by existing roadway or roadside infrastructure, as well as by purpose-built or purpose-installed infrastructure designed to deploy the one or more sensors. A second subset of the plurality of roadway sensor locations can comprise movable deployment locations, where sensors are deployed in combination with a movable device such as a drone, etc. that can be configured or controlled to position itself in various different locations with respect to roadway surfaces.

In some embodiments, the term “roadway location” (e.g., associated with a deployment location of one or more sensors of the road intelligence network) may refer to a sensor deployment location that is adjacent to or nearby a roadway surface, but remains separate from the roadway surface itself. In some aspects, the term “roadway location” may additionally, or alternatively, refer to a sensor deployment location that is on the roadway surface, integrated into the roadway surface, etc. For instance, a roadway location deployment could include wireless or radio receivers that are integrated into the roadway surface and used to receive wireless positioning signals from vehicles traveling thereon, in order to provide highly precise and accurate localization and/or relative positioning information of one or more vehicles on the roadway surface.

In one illustrative example, the systems and techniques described herein can be used to implement a road intelligence network infrastructure of distributed sensors configured to obtain a plurality of sensor data feeds or sensor streams of information that can be used to determine one or more AV control commands (e.g., AV control information) and/or that can be used to determine one or more driver assistance messages (e.g., driver assistance information). As used herein, both AV control information (e.g., used to directly control the movement, navigation, driving, etc., of a vehicle in either an autonomous or semi-autonomous manner) and vehicle assistance information (e.g., provided to a human driver to inform or recommend manual control or driving actions) can be collectively referred to as “ADAS information,” “driving assistance information,” and/or “assistance information.”

In another illustrative example, the systems and techniques described herein can be used to implement the road intelligence network infrastructure of distributed sensors in order to implement one or more automated highway traffic safety administration and/or predictive traffic features. In various embodiments, the road intelligence network systems and techniques can be used to implement both automatically generated driving assistance information that is transmitted to vehicles traveling on a monitored roadway surface, as well as to implement one or more automated highway traffic safety administration notifications. For instance, as will be described in greater depth below, traffic safety notifications can be transmitted and/or otherwise combined with one or more interfaces for local authorities able to take appropriate action in response to a traffic safety notification or traffic event.

### Road Intelligence Network: Distributed Sensing Infrastructure

As will be described in greater depth below, a road intelligence network can be used to capture or obtain a plurality of sensor data streams from a corresponding plurality of sensors and/or other devices that are deployed to various roadway or roadside locations. In some aspects, the road intelligence network can include a distributed sensor infrastructure that is provided adjacent to or otherwise nearby to one or more road surfaces where vehicles will travel, or are anticipated to be traveling. In some embodiments, existing road and highway infrastructure can be augmented (e.g., upgraded) to include at least a portion of the sensor infrastructure associated with the presently disclosed road intelligence network. In some examples, at least a portion of the road intelligence network sensor infrastructure can be integrated with a road or highway at the time of construction (e.g., designed integration vs. retro-fit).

In one illustrative example, the road intelligence network sensor infrastructure includes a plurality of sensors or sensing devices, each associated with a corresponding deployment location that is nearby or otherwise associated with a road surface. The sensor deployment locations can also be referred to herein as “external sensing locations,” based on the fact that the sensor deployment locations are external to (e.g., remote from) a sensor payload that may be included on a vehicle or AV that uses the road surface. In some aspects, the external sensing locations can be fixed or static (e.g., on lampposts, streetlights, or other elevated infrastructure components above the street level, etc.) or may also be mobile (e.g., integrated on or carried as a payload by one or more drones or unmanned aerial vehicles (UAVs), etc.)

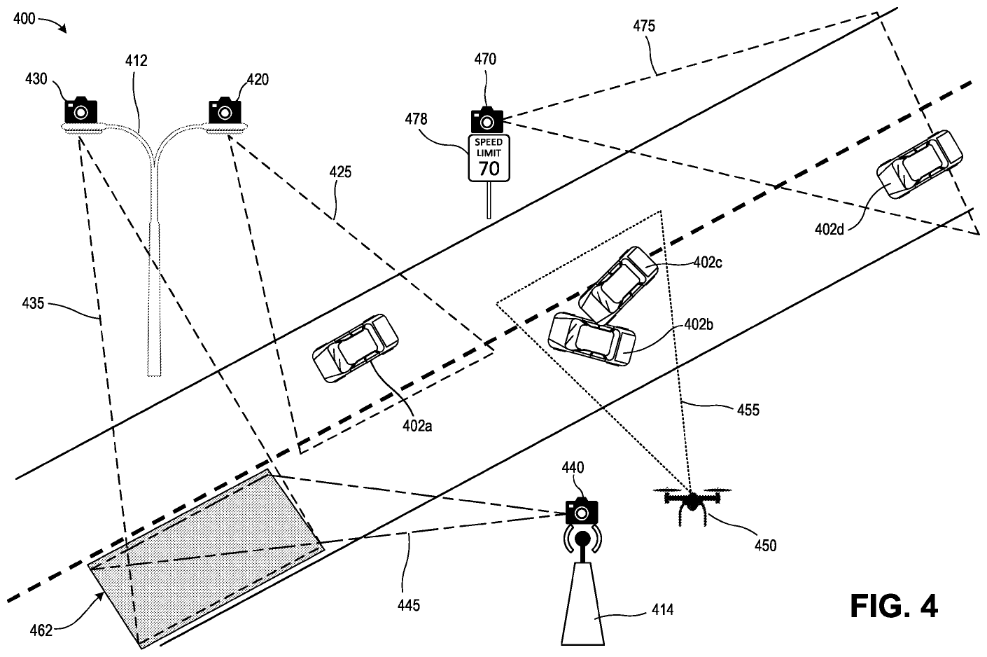

For instance, FIG. 4 is a diagram illustrating an example road intelligence network deployment scenario 400 that can be configured to monitor vehicle activity on a roadway and/or generate driver assistance information, in accordance with some examples. In particular, the example road intelligence network deployment 400 of FIG. 4 corresponds to a portion of roadway infrastructure (e.g., here, a two-lane road surface with both travel lanes in the same direction) that is monitored by a plurality of distributed sensors provided adjacent to the roadway and/or otherwise within the vicinity or nearby environment of the roadway subject to the monitoring.

As illustrated, a first sensor deployment location comprises a streetlamp 412 (e.g., among various other existing highway and roadside infrastructure upon which sensors may be installed or deployed), which is configured or retrofitted with a first camera or imaging sensor 420 and a second camera or imaging sensor 430. Each of the cameras/imaging sensors 420, 430 is associated with a respective field of view (FOV) of a portion of the roadway surface. For instance, the first camera 420 can be used to capture images and/or video corresponding to a field of view 425. The second camera 430 can be used to capture images and/or video data corresponding to a field of view 435. It is noted that the FOVs 425, 435 shown in FIG. 4 are depicted for illustrative purposes only and are not intended to be construed as limiting-cameras and imaging sensors or devices can be configured with various different FOVs and other imaging parameters and characteristics without departing from the scope of the present disclosure.

In some aspects, a camera FOV (e.g., FOV 425, 435 of FIG. 4, etc.) can be a static or fixed FOV. That is, the camera FOV may be non-adjustable without physically repositioning the camera upon the streetlamp 412 and/or may be non-adjustable without changing a lens or other camera intrinsic parameter of the corresponding camera device. In other examples, a camera FOV (e.g., FOV 425, 435, etc.) can be a dynamic or adjustable FOV. For instance, one or more (or both) of the cameras 420, 430 may be repositioned based on a remote control command, based on a programmed movement or panning sequence, based on motion detection or other image/object recognition ML models running locally onboard the camera, etc. The automatic repositioning of the camera 420, 430 can correspond to an automatic adjustment to the corresponding FOV captured by the camera. Panning the camera left or right can move the camera FOV to the left or the right; tilting the camera up or down can move the camera FOV up or down; etc. Camera FOV may additionally, or alternatively, be automatically adjusted based on modifying a zoom level of the camera-zooming in can reduce the camera FOV, zooming out can increase the camera FOV, etc. Adjustments to a camera zoom level may be implemented as optical zoom, digital zoom, or a combination thereof.

In some embodiments, multiple cameras or other sensors of the road intelligence network disclosed herein can be installed upon the same roadside infrastructure (e.g., such as the two cameras 420, 430 installed upon the same roadside streetlamp 412). In some aspects, cameras and other sensors of the road intelligence network can be installed upon various different types and configures of roadside infrastructure.

For example, a third camera 440 may be installed upon a cellular (or other wireless communications) tower 414 that is within the roadside environment or otherwise generally within the vicinity of the road surface (e.g., such that the camera or other sensor installed thereupon has line of sight to at least a portion of the road surface, or is otherwise within sufficient range to capture the desired or intended sensor data corresponding to the road surface and vehicles traveling thereupon).

In some embodiments, the cellular tower 414 may also be referred to as a cellular base station or a wireless network entity, and can include (but is not limited to) a 4G/LTE eNB, a 5G/NR gNB, etc. In one illustrative example, the cellular tower 414 can be associated with a wireless communication network (e.g., a cellular network) that is the same as or similar to the wireless network 100 of FIG. 1. In some embodiments, the cellular tower 414 and associated cellular network can be used to provide a data network backhaul for communicatively coupling the distributed sensor network (e.g., the plurality of sensors) of the road intelligence network described herein. For instance, the cellular tower 414 and associated cellular network of FIG. 4 can provide backhaul internet connectivity, or various other data network backhaul connectivity, among some or all of the various distributed sensors depicted in FIG. 4. In one illustrative example, the cellular tower 414 and associated cellular network can be used to provide backhaul connectivity between one or more (or all) of the first camera 420, the second camera 430, the third camera 440, a fourth camera (or radar, lidar, etc.) sensor unit 470, a drone (or UAV, UAS, etc.) 450, etc. Backhaul internet or other data network connectivity can additionally, or alternatively, be implemented for the presently disclosed road intelligence network and/or distributed sensor infrastructure using one or more of a satellite internet constellation connectivity, wired fiber (e.g., fiber optic cable-based) connectivity, public or private cellular network connectivity, visible-light based communications, etc.

In some aspects, it is contemplated that at least a portion of the distributed sensor system (e.g., the roadside infrastructure comprising the cameras 420, 430, 440, 470 and drone 450 of FIG. 4) can include one or more communications means that are configured to provide direct communications between the distributed sensor system and one or more vehicles within the same environment or area as the distributed sensor(s) of the system. For instance, in addition to passively observing any vehicles traveling on the road surface as they pass through the corresponding camera FOV 425 of camera 420 (e.g., such as vehicle 402a, shown in FIG. 4 as being located fully within the camera FOV 425), the camera 420 can be configured to transmit one or more communications directly to the vehicle 402a. In some embodiments, communications between the distributed sensor system/sensor infrastructure and one or more of the vehicles 402a, 402b, 402c, 402d can be implemented based on various radio (e.g., RF, wireless, etc.) communications protocols, standards, systems, techniques, etc; can be implemented using various laser-based and/or light-based communications systems, protocols, standards, techniques, etc. ; can be implemented using various sound-based communications systems, protocols, standards, techniques, etc; among various others.

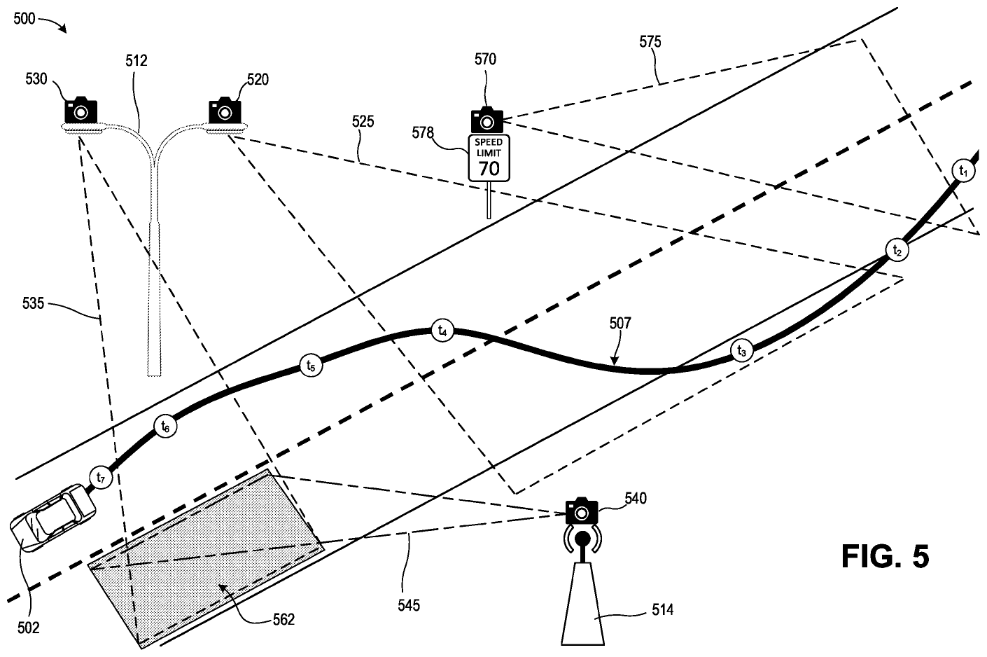

As will be described in greater detail below, the one or more communications can be indicative of driver assistance or monitoring information, which may be derived (by the camera 420 or by a remote/cloud-based analysis engine of the road intelligence network) based on the sensor data captured by the camera 420 itself, may be derived based on sensor data captured by other sensors of the same road intelligence network, and/or may be derived based on any combination(s) thereof. In some embodiments, the backhaul communications network or link used to connect the distributed sensor network and/or other components of the road intelligence network 400 can be used to enable remote monitoring functionality of the road intelligence analysis engine, to enable driving assistance or driving configuration/control (e.g., ADAS configuration/control) functionality of the road intelligence analysis engine, etc. In some aspects, the one or more communications can be indicative of traffic safety notifications or traffic safety monitoring/alert information, which will be described in greater detail with respect to the example of FIG. 5. Similarly, however, the traffic safety information may also be derived (by the camera 420 or by a remote/cloud-based analysis engine of the road intelligence network) based on the sensor data captured by the camera 420 itself, may be derived based on sensor data captured by other sensors of the same road intelligence network, and/or may be derived based on any combination(s) thereof.

More generally, it is contemplated that the presently disclosed road intelligence network can be implemented based on a plurality of local roadside sensor clusters or sensor deployments being connected to a centralized traffic and/or driver monitoring and analysis engine configured to generate various levels of driver assistance information and/or ADAS control or configuration information. In some aspects, the example deployment scenario 400 of FIG. 4 can correspond to a single roadside sensor cluster, which is deployed and configured to obtain streaming sensor data and perform monitoring thereof for the portion of the road surface that is within range of (e.g., covered by the camera FOVs and/or sensor detection areas) the respective roadside sensor cluster.

In one illustrative example, one or more sensor systems (e.g., with a sensor system comprising one or more sensors, of either same or different types in cases where the sensor system includes multiple sensors) can be installed onto lampposts, streetlights, or other elevated infrastructure components at a regular (or semi-regular) interval along the length of a roadway. For instance, the cameras 420, 430 can be installed onto the streetlight 412 at a first deployment location along the roadway surface shown in FIG. 4. The third camera 440 can be installed onto an elevated portion of the cellular tower 414, at a second deployment location along the roadway surface that is different from the first deployment location (e.g., different horizontal position along the road length, different side of the road, different height of installation, different setback or distance from the edge of the road surface, etc.).

The fourth camera 470 can be installed onto a roadside signpost 478, shown here as a speed limit sign (although various other roadside signs, posts, infrastructure, etc., can also be utilized), provided at a third deployment location along the roadway surface that is different from both the first and the second deployment locations.

A fifth camera can be included in or carried as a payload sensor by a drone 450, which is shown in FIG. 4 as being provided at a movable deployment location along the roadway surface (e.g., the current or instantaneous location of the drone on its flightpath above and/or nearby to the roadway surface). Movable or dynamic sensor deployment locations, such as that provided by the drone 450, will be discussed in greater detail below.

In some aspects, one or more cameras, radars, and/or other sensor systems associated with providing vehicle-related sensing and control (e.g., AV-related, ADAS-related, driver monitoring-related, etc.) can be installed onto every lamppost (e.g., such as lamppost 412 of FIG. 4), every other lamppost, etc., along a given street or roadway. In some embodiments, the cameras, radars, and/or other sensor systems contemplated herein can be integrated into a single module or housing for more efficient installation above the roadway. For instance, the camera 470 installed on the speed limit sign 478 may be combined or otherwise integrated with a radar sensor unit within a single or shared housing, such that the multi-sensor housing is installed upon the speed limit sign 478 and provides a deployment of the multiple sensors contained therein (e.g., at least the camera 470 and the radar sensor unit, etc.). In another example, the multiple cameras 420, 430 shown in FIG. 4 as installed in two separate locations or relative positions on the streetlight 412 may alternatively be integrated into a combined housing or sensor module that requires only a single installation to be performed on streetlight 412 in order to deploy at least the two cameras 420, 430 for monitoring the roadway surface.

In some embodiments, one or more sensor systems can be installed in the street and on the ground. In other examples, the sensor systems can be installed so that the sensors stay proximate (e.g., within a threshold, predetermined distance, etc.) to a location. In some embodiments, there are a plurality of vehicles driving around a particular location/area with sensors located in the vehicles. Vehicles can then drive around any of the sensored plurality of vehicles, similar to the overhead lights.

For instance, reference made herein to a vehicle or AV may refer to one or more (or all) of the various vehicles 402a, 402b, 402c, 402d that are shown on and within the monitored roadway surface region of the road intelligence network 400 of FIG. 4. The different vehicles are shown to illustrate different example monitoring and driver assistance/ADAS configuration information generation scenarios that can be implemented using the presently disclosed road intelligence network. For instance, the first vehicle 402a can be monitored by at least the camera 420 while the first vehicle 402a is located within the corresponding camera FOV 425 (e.g., while traveling on the roadway surface within the area or region of the camera FOV 425). The fourth vehicle 402d can be monitored by at least the camera/radar unit 470 while passing through or located within the corresponding camera/radar FOV 475.

In one illustrative example, the different sensor deployment locations within a given roadside environment or roadside area such as that shown in FIG. 4 can communicate amongst one another and perform information sharing from “upstream” sensors/sensor deployment locations to “downstream” sensors/sensor deployment locations. An upstream sensor or sensor deployment location is closer to an origin point of vehicle traffic than a downstream sensor or sensor deployment location, and the classification of upstream vs. downstream can be based on the direction of travel. For instance, the example of FIG. 4 corresponds to a direction of travel that is from the right to the left (e.g., vehicle 402a is “ahead” of the vehicles 402b, 402c which are themselves “ahead” of the vehicle 402d). The speed camera/radar sensor 470 can be considered an “upstream” sensor and sensor deployment location relative to both the camera 440/cell tower 414 and the streetlight 412/cameras 420 and 430. The camera 440/cell tower 414 can be considered “upstream” of the streetlight 412/cameras 420 and 430. Similarly, the streetlight 414/cameras 420 and 430 may be considered “downstream” from both the cell tower 414/camera 440 and the speed sign 478/camera 470. The cell tower 414/camera 440 is also itself “downstream” from the speed sign 478/camera 470.

In some embodiments, communications and information sharing from upstream sensors/locations to downstream sensors/locations can be implemented in order to provide priors (from the upstream sensor(s)) to the downstream sensor(s), where the provided priors are indicative of information such as the particular vehicles and/or driving or traffic behavior that the downstream sensor locations should expect to see in the near future (i.e., once the vehicle travels the distance separating the upstream sensor location from the downstream sensor location).

For instance, the speed camera/radar 470 is the most upstream sensor deployment location shown in FIG. 4, and has a corresponding FOV 475 that spans the entire width of the two traffic lanes of the monitored roadway surface. Accordingly, the speed camera/radar 470 captured sensor information of vehicles detected or monitored within the FOV 475 may be shared to the downstream sensors (e.g., camera 440, 430, 420, etc.) prior to the respective vehicle entering the corresponding camera FOVs 445, 435, 425, respectively.

Notably, the information sharing and communications between neighboring sensors and sensor deployment locations in a roadside environment (e.g., information sharing and communications from upstream sensors 470, 450, and/or 440 to the respective downstream sensors 450, 440, 420, and/or 430) can be used to enable more effective and efficient interpretation of sensor data at the downstream sensor deployment locations. For instance, if the speed camera/radar sensor 470 detects that vehicle 402d is traveling at a very high rate of speed (e.g., 115 mph or some other speed far in excess of the posted 70mph speed limit 478), the information sharing to provide a prior from camera 470 to the cameras 420, 430 can cause the cameras 420, 430 to take appropriate configuration changes in anticipation of monitoring the vehicle indicated in the prior (e.g., the speeding vehicle 402d). In some aspects, sensor modification or configuration changes based on upstream priors information sharing can include actions such as increasing frame rate or resolution of the cameras 420, 430 (e.g., increased from a default low value utilized to minimize bandwidth or storage consumption, to a relatively high or maximum value in anticipation of using a captured image to generate an automatic speeding ticket, etc.).

As noted previously, based on the installation of the sensor system modules at an elevated location above a roadway, each sensor system can be associated with a known field of view (FOV) (e.g., such as the known FOVs 425, 435, 445, 455, 475 of FIG. 4). For example, the sensor system module can be installed in a downward orientation, such that the camera(s) and radar(s) included on the sensor system module capture sensor data corresponding to one or more vehicles, pedestrians, etc., moving along the roadway surface in the FOV below the sensor system module. In some embodiments, each sensor system module can be associated with a corresponding coverage area within the surrounding or local environment in which aspects of the present disclosure are implemented. For example, the coverage area of each sensor system module can be the FOV of the sensor system module (e.g., which can be determined based on a combination of the height of the sensor system module above the roadway surface, the angular field of view of the sensor(s) included in the sensor system, the resolution of the sensor(s) included in the sensor system, etc.).

In some embodiments, each installed sensor system module can be associated with a geographic location or coordinate (e.g., GPS coordinate) that can be used, along with intrinsic information of the discrete sensors within the sensor system module, to determine a total coverage area provided by a plurality of installed sensor system modules. In some cases, an installation height and/or an installation interval between adjacent installed sensor system modules can be determined to provide continuous coverage of a roadway surface of interest. For example, given the spacing of existing streetlights, lampposts, traffic lights, power poles, etc. (collectively referred to herein as “infrastructure elements”), an installation height can be determined for each infrastructure element that will result in continuous coverage of the roadway surface.

In some aspects, continuous coverage can be obtained based on an overlapping FOV between adjacent installed sensor system modules, such that a vehicle enters the FOV of a second sensor system module before exiting the FOV of a first sensor system module. For instance, the example of FIG. 4 depicts an overlapping FOV monitoring area 462 that comprises an intersection or union between the camera 430 FOV 435 (originating from a first location on a first side of the road) and the camera 440 FOG 445 (originating from a different, second location on the opposite side of the road). In some aspects, the overlapping FOV monitoring area 462 can be utilized for a more comprehensive, thorough, detailed, etc., monitoring or other analysis of the vehicles that travel within and through the overlapping FOV monitoring area 462. For instance, by capture the same vehicle from multiple different perspectives/angles/FOVs while the vehicle travels within the overlapping FOV monitoring area 462, additional and/or more detailed information can be determined corresponding to the vehicle and/or the driver of the vehicle. In some aspects, the overlapping FOV monitoring area 462 can be a pre-determined or specifically configured area on the roadway surface that is selected for enhanced monitoring via the multiple sensors and multiple sensor FOVs that capture monitoring information. In other words, the deployment of the cameras 440, 430 that are associated with the overlapping FOV monitoring area 462 can be configured or designed to achieve a desired FOV overlap for enhanced monitoring within a desired area or portion of the roadway surface (e.g., the desired area of road surface being the same as, or included within, the overlapping FOV monitoring area 462).

It is further noted that although reference is made herein to a “roadway surface,” this is done for purposes of example, and it is contemplated that the presently disclosed sensor system modules can be installed to provide coverage of any surface that is suitable for vehicle travel (e.g., parking lots, dirt or gravel roads, grassy fields used for stadium and event parking, driveways, etc.). As used herein, “roadway surface” may also refer to both the surface upon which vehicles are driven (whether paved or otherwise) as well as adjacent pedestrian areas, which can include, but are not limited to, sidewalks, medians, shoulders, emergency or breakdown lanes, etc.

In some embodiments, one or more (or all) of the plurality of sensor system modules can utilize solar power and/or mains power. For example, a sensor system module can include one or more solar panels or solar arrays that can be used to provide electrical power for the sensor system module (which may include a battery for storing electrical power). In some aspects, a sensor system module can be connected to the same electrical grid that powers a streetlight (e.g., streetlight 412) or traffic to which the sensor system module is mounted. In other cases, a sensor system module can be installed on a power pole and may be connected to electrical power via one or more appropriate interfaces between the sensor system module and the electrical supply lines carried by the power pole. In some aspects, a sensor system module can be installed in various locations above the roadway (e.g., on various infrastructure elements) and be connected to electrical power via a dedicated connection.

In one illustrative example, the sensor system modules can be communicatively coupled to one or more computational systems for processing the sensor data obtained by the sensor system modules. For example, in some cases, one or more (or all) of the sensor system modules can include local computational capabilities for processing the respective sensor data captured by each sensor system module. In other examples, one or more (or all) of the sensor system modules can be associated with a remote compute node that is external to the sensor system module(s). For example, if a plurality of sensor system modules are installed along a 5-mile stretch of roadway, a remote compute node may be installed at a regular or semi-regular interval (e.g., every block, every other block, every mile, etc.) that is larger than the interval at which the sensor system modules are installed (e.g., each remote compute node can obtain and process collected sensor data from multiple different sensor system modules).

The sensor system modules can communicate with a remote compute node via a wired connection and/or via a wireless connection. Various wireless communications standards, protocols, and implementations may be utilized, as noted and described previously above. The computational systems contemplated herein (e.g., whether integrated compute provided at each sensor system module, a remote compute node installed in combination with each sensor system module, and/or a remote compute node communicatively coupled to multiple different sensor system modules) can be powered via the same electrical connections used to power the sensor system modules, as described previously above.

### Road Intelligence Network: Driver Assistance Based on Distributed Sensor Data

Based on the installation of a plurality of sensor system modules, a robust understanding of the location(s) of one or more vehicles, pedestrians, and/or other objects within the covered area can be obtained by processing and analyzing the captured sensor data using the corresponding computational systems associated with the plurality of sensor system modules. In some aspects, the term “covered area” may refer to the combined or composite FOV obtained by combining the discrete FOVs captured by each individual sensor system module of the plurality of sensor system modules. For example, the “covered area” or “monitored area” of the road intelligence network deployment 400 of FIG. 4 can correspond to the combination (e.g., union, intersection, etc.) of the discrete camera and/or sensor FOVs 425, 435, 445, 455, 475 that are shown in FIG. 4. In other examples, the term “covered area” or “monitored area” may refer to the discrete FOV captured by an individual sensor system module—e.g., in this example, each of the individual FOVs 425, 435, 445, 455, 475, and/or the overlapping FOV area 462 can be referred to as respective “covered areas” or “monitored areas.”

In some aspects, it is contemplated that the sensor data can be processed jointly (e.g., for multiple ones, or all, of the installed sensor system modules in a given area) to generate a composite FOV in which autonomous vehicle control can be implemented. For example, a composite FOV can be associated with the entire covered area in which sensor system modules are installed, or multiple composite FOVs can each be associated with a sub-section of an overall covered area in which sensor system modules are installed (e.g., a composite FOV can be generated and processed on a block-by-block basis, or some other interval greater than the spacing interval between adjacent ones of the installed sensor system modules).

It is also contemplated that the sensor data may be processed individually (e.g., for individual ones of the installed sensor system modules) to generate a corresponding plurality of processed FOVs in which autonomous vehicle control can be implemented. For example, a first FOV associated with a first sensor system module can be processed separately from a second FOV associated with a second sensor system module adjacent to the first sensor system module. For instance, the sensor streaming data from camera 420 and FOV 425 can be processed separately to determine or otherwise obtain monitoring information corresponding to the first vehicle 402a. The sensor streaming data from camera 470 and FOV 475 can be processed separately to determine or otherwise obtain monitoring information corresponding to the fourth vehicle 402d. The sensor streaming data from drone-based camera 450 and the movable FOV 455 can be processed separately to determine or otherwise obtain monitoring information corresponding to the second and third vehicles 402b, 402c and/or to obtain monitoring information or generate traffic safety alert information corresponding to the accident/collision shown between the vehicles 402b and 402c.

When a vehicle is detected within the first FOV (e.g., based on sensor data captured by the first sensor system module), one or more autonomous vehicle controls or other monitoring functions can be implemented for the vehicle while it remains within the first FOV associated with the first sensor system module. When the vehicle exits or begins to move out of the first FOV (e.g., and into the adjacent second FOV associated with the second sensor system module), a handover can occur between the first and second sensor system modules. During the handover, the one or more autonomous vehicle controls or other monitoring functions can transition to being implemented for the vehicle based on processing and analyzing the sensor data captured by the second sensor system module, rather than the sensor data captured by the first sensor system module. In some aspects, handover can be associated with control information, telemetry data, or other control metadata generated by the first sensor system module being provided as input to the second sensor system module (e.g., when the vehicle moves from the first FOV to the second FOV, the first sensor system module can provide the second sensor system module with state information of the vehicle, such as its current speed, current heading, and/or currently executed autonomous navigation/control command).

In some aspects, the computational systems described herein (e.g., the local or remote compute associated with each sensor system module and utilized to process and analyze the corresponding captured sensor data) can be used to learn, over time, one or more patterns of traffic flow or other traffic information associated with a particular FOV of a covered area. For example, patterns of traffic flow and other traffic information can be learned in association with an FOV captured by a single sensor system module (e.g., in the example in which each sensor system module's FOV is processed separately) and/or can be learned in associated with a combined FOV captured by multiple sensor system modules in a contiguous geographic area (e.g., in the example in which multiple sensor system module FOVs are fused or otherwise jointly processed for a composite covered area). In one illustrative example, the overlapping FOV area 462 that is covered by the camera 430 and corresponding camera FOV 435, and also the camera 440 and corresponding camera FOV 445, can be configured as a static area 462 associated with or utilized for learning traffic behaviors and/or traffic flows and patterns over time, based on observing vehicle travel behaviors and parameters within the constant monitoring location provided by the overlapping FOV area 462.

In some embodiments, vehicles, pedestrians, and/or other objects that are moving (or otherwise present) within an FOV captured by one or more sensor system modules can be tracked using one or more machine learning (ML) networks and/or artificial intelligence (AI) networks. In some cases, machine vision can be used to automatically detect and classify moving objects using one or more images captured by a camera or other sensor(s) included in the sensor system module. For example, machine vision can be used to automatically detect vehicles, pedestrians, animals, etc., using one or more images captured by the sensor system module. In some aspects, the one or more images captured by the sensor system module can include one or more of visible light images (e.g., RGB or other color spectrum images), infrared images, etc. For example, visible light images can be used to perform object detection and classification based on visual characteristics such as shape, color, etc., and may be combined with thermal (e.g., infrared) imaging that may be used to better differentiate vehicles and pedestrians from the background features of the environment based on the corresponding thermal signature(s) of vehicles and pedestrians.

The one or more images can be provided as input to a computer vision system and/or a trained ML network, which can detect and classify (and/or identify) one or more objects of interest. As utilized herein, objects of interest can refer to vehicles, pedestrians, animals, and/or other objects that may be present in or near the roadway being monitored. In some examples, the computer vision system and/or trained ML network can determine one or more unique identities for each detected object of interest, such that each detected object of interest can be tracked over time. For example, rather than performing a discrete object detection and classification task for each captured frame of image data, the object detection and classification task can be performed over time, such that an object previously detected and classified in a previous frame is detected and associated with an updated location/position in subsequent frames. Such an approach can be used to track the movement of a vehicle, pedestrian, or other object of interest over time and through/within the FOV associated with the currently analyzed covered area.

In some embodiments, the systems and techniques described herein can utilize one or more neural networks to perform detection and tracking of vehicles and other objects of interest within the FOV captured by one or more sensor system modules for a given covered area (e.g., recalling that a given covered area can correspond to the FOV of a single sensor system module or the combined FOV of multiple sensor system modules). The one or more neural networks disclosed herein can be provided as recurrent networks, non-recurrent networks, or some combination of the two, as will be described in greater depth below. For example, recurrent models can include, but are not limited to, recurrent neural networks (RNNs), gated recurrent units (GRUs), and long short-term memory (LSTMs). Additionally, the one or more neural networks disclosed herein can be configured as fully connected network networks, convolutional neural networks (CNNs), or some combination of the two.

In some aspects, the one or more neural networks can learn, over time, a baseline expectation of the patterns of traffic, traffic flow, driver behavior, pedestrian behavior, etc., that characterize the movements and interactions of various objects of interest within that given FOV. For instance, the one or more neural networks can learn a prior view of the expected traffic flow and traffic characteristics through the covered area of the FOV that is sufficient to make one or more predictions about what a given vehicle or pedestrian is likely to do in the future-these short-term predictions can extend over the period of the time that the vehicle or pedestrian is expected or estimated to remain within the FOV of the covered area (e.g., because upon exiting the FOV of the covered area, control and analytical responsibility is handed over to the next or adjacent FOV covered area, as described above).

In one illustrative example, the drone 450 can be deployed to capture the collision between vehicles 402b, 402c within its movable FOV 455, based on the road intelligence network analysis engine detecting the collision on the basis of its deviation from expected traffic flow and expected traffic characteristics within the monitored roadway environment of FIG. 4. For instance, either the collision itself may be directly detected, or the deviation behavior of vehicle 402c crossing the dividing middle line and/or vehicle 402b having a mis-aligned orientation relative to the travel lanes of the road can be used to automatically determine that a collision (or more generally, a traffic safety event) has occurred. As illustrated, the collision between vehicles 402b and 402c takes place at a location on the roadway surface that is not captured by any of the other camera FOVs 425, 435, 445, or 475 that are shown in FIG. 4. In some embodiments, the collision between the vehicles 402b and 402c can be predicted or inferred based on the last known locations and behaviors of the two respective vehicles 402b and 402c when they were most recently observed by the road intelligence network system 400 (e.g., while the two vehicles 402b, 402c were still located within camera FOV 475 and corresponding image or video data was captured of the vehicles 402b, 402c by the camera 470).

Based on the one or more predictions generated for the detected objects of interest, the systems and techniques can make enhanced or improved predictions for better controlling the movement or behavior of one or more autonomous vehicles within the FOV of the covered area. For example, the systems and techniques may receive as input additional or supplemental data indicative of an intended destination of one or more vehicles currently within the FOV of the covered area, and can use this supplemental information to generate improved predictions, recommended control actions, and/or direct AV control commands that optimize the traffic flow through the covered FOV and more efficiently route vehicles in the covered FOV to their final destination (e.g., if the final destination is located within the covered FOV) or to more efficiently route vehicles in the covered FOV to a handover point to the next/adjacent covered FOV (e.g., if the final destination is not located with the current covered FOV).

In some aspects, handover between two covered FOV areas (e.g., two adjacent covered FOV areas) can be performed based on a pre-defined boundary or handover zone between the two covered FOV areas. In some embodiments, handover (e.g., the handoff of communication and control for a given autonomously controlled or monitored vehicle) can be performed based on selecting an FOV coverage area that is determined to provide optimal or improved performance. For example, if two covered FOV areas overlap by 100 ft, a vehicle starting in a first FOV may remain under the control and monitoring of the first FOV until the vehicle is closer to the outer boundary of the first FOV than it is to the outer boundary of the second FOV (e.g., for a 100 ft overlap, assuming circular FOV areas, once the vehicle is more than 50 ft into the overlap area control and monitoring functions can be handed over to the second FOV). In some aspects, the selection of an FOV coverage area to perform autonomous control and monitoring of a vehicle can be performed dynamically, based on factors that may include, but are not limited to, current coverage quality, current and past performance of the candidate FOV coverage areas, roadway topography or features, etc.

In some embodiments, one or more interfaces can be provided to vehicles, as will be described in greater depth below. In some aspects, the vehicles may be standalone autonomous vehicles (e.g., fully autonomous, such as ADAS level 5; or partially autonomous, such as ADAS levels 1-4) that are capable of controlling one or more vehicle systems (e.g., acceleration functionality, steering functionality, the power management system 251, control system 252, infotainment system 254, intelligent transport system 255, vehicle computing system 250, communications system 258, and/or sensor system(s) 256 each illustrated in the example of FIG. 2, etc.) based on one or more autonomous control commands or otherwise without human input. In some aspects, the vehicles may be what are referred to as legacy vehicles, which lack autonomous driving capabilities but otherwise still implement electronic control and monitoring systems that are operated with human assistance or intervention. For example, both autonomous vehicles and legacy vehicles may implement some form of a Controller Area Network (CAN bus) that allows microcontrollers and vehicle systems/sub-systems to communicate with each other.

In one illustrative example, the systems and techniques can include an interface for receiving a desired or intended destination for a vehicle. For example, the destination can be input by a driver or passenger of the vehicle, such as by using an onboard navigation system or navigation interface included in the vehicle and/or by using a paired mobile computing device (e.g., a smartphone) to input the desired or intended destination for the vehicle. Based on the input destination information, the systems and techniques can remotely control (e.g., autonomously control) the vehicle for the portion of the route to the destination that passes through a covered FOV area with installed overhead sensor system modules, as described above. For example, a desired destination may be initially received when the route begins (e.g., while a vehicle is parked at the driver's home, in a driveway, along the side of a street, etc.), at a location that is outside of the FOV coverage area(s). In such a scenario, the driver may manually drive the car along an initial portion of the route to their final destination (or, in the case of an autonomous vehicle, the vehicle may autonomously navigate along the initial portion of the route).

Upon reaching and entering an FOV coverage area, a handoff can be performed to pass navigation control and/or monitoring functionalities to the autonomous systems described herein. For instance, FOV coverage areas may be installed in dense urban cores, city downtowns, expressways, interstates, parking lots, etc., while FOV coverage areas may not (initially) be installed to cover lower traffic density areas, such as suburban areas. In some cases, initial handoff of control to the autonomous systems described herein can be performed automatically upon the vehicle initially entering an FOV coverage area. In some examples, handoff may be affirmatively confirmed by a driver or passenger within the vehicle.

In some embodiments, initial handoff of vehicular control can be performed based on performing a trigger action or other pre-determined handoff action. For example, initial handoff of vehicular control may be performed based on a driver parking his or her vehicle within an FOV coverage area and turning off the vehicle ignition. When the vehicle ignition is subsequently turned back on, the vehicle can be automatically registered to the autonomous control system described herein and can be autonomously controlled to move within the starting FOV coverage area and one or more adjacent FOV coverage areas. In some examples, a handoff of vehicular control may be performed based on the driver starting the vehicle within an FOV coverage area (during which time autonomous control is provided) and subsequently driving it from a parking space to a location outside of the FOV coverage area (at which time control reverts to the driver or an onboard autonomous system of the vehicle). In some embodiments, an interface can be provided to permit a driver to take over control of a vehicle that is being autonomously controlled within an FOV coverage area, wherein control may be handed over from the autonomous control systems described herein to either the driver's manual control or the onboard autonomous control of the vehicle.

In some aspects, the systems and techniques can be used to perform one or more monitoring functions and/or to implement one or more rule-based control functions. For example, one or more FOV coverage areas can correspond to a section of roadway(s) for which local authorities wish to implement certain control measures-such control measures (whether temporary or permanent) can be implemented via one or more rules monitored and/or enforced by the autonomous control system described herein. For instance, local authorities can provide ongoing and/or updated instructions indicative of whether vehicles are and are not permitted to travel, indicative of patterns of vehicular behavior that are not allowed, etc. In some embodiments, an autonomously controlled vehicle can be automatically halted based on the systems and techniques determining that the vehicle's behavior has violated one or more constraints enforced by the system. In some aspects, an autonomously controlled vehicle may additionally, or alternatively, be halted based on the systems and techniques determining that the vehicle is at excess risk of hitting a pedestrian, object, other vehicle, or otherwise doing damage.

For instance, FIG. 5 is a diagram illustrating an example road intelligence network deployment scenario 500 that can be configured to monitor vehicle activity on a roadway and/or generate traffic safety notifications in response to automatically detecting and/or identifying an erratic driving behavior within the monitored zone of the road intelligence network.

In some aspects, the road intelligence network deployment 500 of FIG. 5 can include components that are the same as or similar to like components in the road intelligence network deployment 400 of FIG. 4. For instance, a streetlight 512 and cameras 520, 530 of FIG. 5 can be the same as or similar to the corresponding streetlight 412 and cameras 420, 430 of FIG. 4; a camera 540 and cell tower 514 of FIG. 5 can be the same as or similar to the corresponding camera 440 and cell tower 414 of FIG. 4; the camera FOVs 525, 535, 545 of FIG. 5 can be the same as or similar to the corresponding camera FOVs 425, 435, 445 of FIG. 4; an overlapping FOV monitored area 562 of FIG. 5 can be the same as or similar to the corresponding overlapping FOV monitored area 462 of FIG. 4; a speed limit sign 578 and camera 570 of FIG. 5 can be the same as or similar to the corresponding speed limit sign 478 and camera 470 of FIG. 4; a camera FOV 575 of FIG. 5 can be the same as or similar to the corresponding camera FOV 475 of FIG. 4; etc.

As illustrated, FIG. 5 depicts a prior travel path 507 taken by vehicle 502 as it travels from right to left along the roadway surface (e.g., with the vehicle 502 having been previously located at the indicated points in time t₁, t₂, . . . , t₇ shown on the path 507 in FIG. 5). In some examples, the prior travel path 507 exhibits poor lane control, and may correspond to an example of an intoxicated, incapacitated, or otherwise inattentive driver at the wheel of vehicle 502.

The systems and techniques described herein can be used to automatically detect the erratic driving behavior associated with vehicle 502 and the path 507, based on combining and analyzing the sensor feeds obtained from the various distributed sensors and corresponding to the respective FOVs 575, 525, 545, 535. In some embodiments, the road intelligence network can obtain a series of observations over time, where a portion of the observations are directly or explicit observations of the vehicle 502 behavior within a monitored area of a camera FOV and with a remaining portion being inferred or predicted vehicle 502 behavior corresponding to times where the vehicle 502 and path 507 are not within any one or more of the monitored camera FOV zones of the road intelligence network. For instance, at time t₁ the vehicle 502 is still outside of the monitored zone of camera FOV 575, and the system may not yet be aware of the vehicle's presence (or may be aware of the vehicle 502's predicted presence at the t₁ location, based on information sharing of upstream priors observing the same vehicle 502 at an upstream location of the same roadway).

Between times t₁ and t₂, the vehicle's path 507 passes through a portion of the monitored zone of camera FOV 575, and the system can use the observed data within the monitored zone of camera FOV 575 to generate and/or update a trajectory prediction for the vehicle 502, where the trajectory prediction corresponds to the portion of path 507 that is between the monitored camera FOV zones 575 and 525. In some aspects, the observed data within monitored camera FOV zone 575 and/or the trajectory prediction for vehicle 502 immediately after leaving the monitored camera FOV zone 575 can be shared from the upstream camera 570 to one or more (or all) of the downstream cameras 520, 540, 530 as a prior for the vehicle 502.

In some aspects, if the trajectory prediction for vehicle 502 corresponding to the time t₂ location along path 507 is sufficiently reliable or confidence (e.g., greater than a configured threshold value confidence, etc.), the road intelligence network may generate a traffic safety alert or erratic driving alert based on the predicted trajectory of vehicle 502 at time t₂ swerving outside of the lane boundaries of the road.

In some examples, the trajectory prediction for vehicle 502 at the t₂ location may be insufficiently confident, or an additional confirmation may be desired before generating a traffic safety alert or erratic driving alert for vehicle 502. In such examples, the road intelligence network system 500 of FIG. 5 can subsequently obtain a time series of monitoring data or sensor observations of the vehicle 502 for the portion of the path 507 that is within the monitored camera FOV zone 525 corresponding to camera 520. For instance, both the time t₃ location and the time t₄ location along path 507 of vehicle 502 may be characterized by explicit monitoring observations from camera 520 of the vehicle 502 behavior.

As illustrated, at the time t₃ location along path 507, the vehicle 502 is observed in the image or video data as continuing to swerve outside of the lane boundary for the roadway. Between the time t₃ and time t₄ locations along path 507, the vehicle 502 is directly observed in the image or video data as swerving back towards the center of the roadway, in an overcompensated swerve that takes the vehicle 502 from being located outside of the far left lane boundary at t₃ to being located in the far right lane at the time t₄ location along path 507.

In some embodiments, the double confirmation provided by the two explicit camera/sensor observations from camera 520 within the monitored camera FOV zone 525 at times t₃ and t₄ may be taken as sufficiently indicative of erratic driving behavior (e.g., intoxicated, incapacitated, inattentive, etc., driver of the vehicle 502), and corresponding traffic safety alert and/or erratic driving alert information, notifications, messages, etc., may be automatically generated by the road intelligence system 500.

In some embodiments, the road intelligence network system 500 can, after generating the traffic safety alert/erratic driving alert at time t₄, generate and transmit to the ADAS or other control (autonomous or semi-autonomous, assistive, etc.) system of the vehicle 502 one or more pieces of driver assistance or control information that are configured to bring the path 507 of the vehicle 502 back into the expected behavior of remaining within one of the two travel lanes of the roadway surface.

For instance, at the time ts location along path 507, the vehicle 502 begins to stabilize its path and trajectory to be centered within the right travel lane of the roadway. Because the time ts location is outside of a monitored camera FOV zone (e.g., between monitored camera FOV zone 525 and monitored camera FOV zone 535), the road intelligence network system 500 may not have sufficient information to generate further course correction commands that can be transmitted to the vehicle 502 as additional driver assistance or ADAS configuration/control information. Accordingly, the trajectory 507 of vehicle 502 may drift slightly away from center during the portion of the trajectory/path 507 that is outside of both the camera FOVs 525 and 535.

At time t₆, the vehicle 502 and path 507 are within the monitored camera FOV zone 535 corresponding to the camera 530, and the direct/explicit monitoring observations of the vehicle 502 and its behavior can be used by the road intelligence network system 500 to generate additional driver assistance or ADAS configuration/control commands that cause the path trajectory 507 to again stabilize back towards the centerline of the right travel lane of the roadway (e.g., shown as the location at time t₇ returning to the centerline of the right lane, relative to the location at time to that is to the right of the center line).

In some embodiments, the driver assistance or ADAS configuration/control commands generated by the road intelligence network system 500 can vary based on a desired or configured ADAS level for controlling the vehicle 502, and/or a maximum supported or maximum enabled ADAS level for control of the vehicle 502.

For instance, at ADAS Level 0 (no automation), the road intelligence network system 500 can send driver assistance information notifying the driver of vehicle 502 of the erratic behavior and prompting the driver to perform a manual correction. At ADAS Level 1 (driver assistance), single-task automation may be performed based on an ADAS Level 1 configuration/control command sent to the vehicle 502. For instance, the ADAS Level 1 configuration/control command can cause the vehicle 502 to perform autonomous lane following to regain lane position along the centerline.

At ADAS Level 2 (partial automation), the vehicle 502 can receive an ADAS Level 2 configuration/control command that causes the vehicle 502 to perform multiple task automation (e.g., lane following to regain centerline, and acceleration to control to bring the vehicle 502 to a reduced or zero speed over time; or lane following control and acceleration control implemented as ADAS commands that cause the vehicle 502 to automatically be pulled over/pull itself over and come to a stop on the side/shoulder of the roadway). The same or similar principle can apply for using the road intelligence network system 500 to automatically generate corresponding ADAS configuration/control commands for the higher ADAS levels that may be supported by the vehicle 502.

As mentioned previously, the systems and techniques can perform computations, monitoring, prediction, and autonomous control based on sensor data obtained from a plurality of installed overhead sensor system modules. In some embodiments, the systems and techniques can receive raw (e.g., un-processed or minimally processed) sensor data as captured by the overhead sensor system modules. In some cases, the systems and techniques can additionally, or alternatively, receive pre-processed or already processed data that was generated based on the raw captured sensor data. For example, pre-processed data can be locally processed by the corresponding sensor system module (e.g., using a local compute system) prior to being transmitted in a processed for to the autonomous control system described herein. In other examples, raw sensor data can be transmitted from the one or more sensor system modules to one or more remote compute nodes, wherein each remote compute node is responsible for collecting and processing data from one or more different overhead sensor system modules. The remote compute node(s) may subsequently process the received sensor data and transmit, to the autonomous control system disclosed herein, a combination of pre-processed and un-processed/raw sensor data as needed.

In some aspects, the pre-processed data received by the autonomous control system can include abstract geometry of where one or more objects (e.g., objects of interest) are located within a given or corresponding FOV coverage area. The pre-processed data may additionally, or alternatively, include telemetry or kinematic information such as the speed and direction (e.g., heading) of any moving objects within the FOV coverage area. In some cases, the pre-processed data can be indicative of one or more probabilities about future change(s) in direction and/or speed. Probability information can further include collision probabilities, lane or roadway deviation probabilities, etc.

In some embodiments, the systems and techniques can include one or more interfaces for notifying vehicle occupants (e.g., driver, passengers, etc.) about facts (or changes to facts) about coverage areas that the vehicle is entering or exiting. For example, if certain rules are enforced for a section of roadway within an FOV coverage area that limit the maximum speed, prevent lane changes, or close one or more portions of the roadway, the occupants of a vehicle can be notified upon entering the corresponding FOV coverage area (or slightly prior to entering the corresponding FOV coverage area, based on a determination that the predicted route of the vehicle will pass through the FOV coverage area). In some cases, vehicle occupants may be notified based in part on a determination that the vehicle occupants have not previously or not yet been notified.

In some embodiments where there is a human driver (e.g., legacy vehicles) overhead sensors may provide an interface that enables a vehicle to be controlled by remote drivers, for example, in a call center. In some examples, the system is configured to prevent crashes and the remote driver is configured to handle other situations, for example, where the system is not enabled or able to control the vehicle. The remote drivers may see high quality video or a vectorized abstraction that enables them with a threshold amount of information for safely driving the vehicle, while consuming less bandwidth.

In some embodiments, the systems and techniques described herein can be utilized to provide or otherwise may include one or more interfaces for local authorities (e.g., governments of public spaces, owners of private spaces, etc.) that summarize patterns of behavior for vehicles within one or more monitored and/or controlled FOV coverage areas. This information can be used to perform actions such as charging for tickets (e.g., for moving violations, vehicular violations, etc.), charging for parking, etc. In some aspects, the interface(s) can be used to submit queries to one or more databases of vehicles and/or logged vehicle behaviors, wherein the queries can be matched to specific vehicle characteristics and/or vehicle behaviors of interest.

The interfaces provided for local authorities can also be used for ingestion and configuration of one or more rule sets that should be enforced to control vehicle behavior when certain conditions are met or violated, as described above. For example, vehicles may autonomously and/or automatically be halted if certain conditions or rules are violated, and these conditions and rules may be specified using the aforementioned interface(s). In one illustrative example, local authorities can use the interface(s) to specify the rules and conditions that should precipitate a halt to a vehicle and/or to specify one or more constraints on how a vehicle should be controlled (e.g., halt a vehicle violating a rule, or modify a vehicle's speed/autonomously controlled behavior to bring it into compliance with a rule that was being violated, etc.). Based on the granularity of control provided to local authorities via the one or more control interfaces described above, the systems and techniques can be used to change instructions, control modes and configurations, etc., in order to optimize the flow of traffic through a given FOV coverage area as is preferred or desired by the local authorities. In some embodiments, the control interfaces for local authorities can be integrated with existing traffic control systems and infrastructure, such as stoplights and the programmed behavior of stoplights. For example, the control interfaces for local authorities can be used to optimize, control, update, or otherwise modify signaling for traffic lights (e.g., pattern/cycle of red, green, yellow light behavior) based on how the traffic light behavior should change based on traffic in the area. For instance, traffic in an FOV coverage area can be dynamically analyzed in substantially real-time to determine an optimal traffic light behavior control signaling for one or more traffic lights, both within the given FOV coverage area and within adjacent or external FOV coverage areas. In some cases, the analysis of distributed sensor infrastructure streaming data can be performed automatically (e.g., using an AI and/or ML-based road intelligence engine). In some cases, human-in-the-loop interventions or additional human inputs, analysis, information, etc., may be provided to the automated road intelligence engine. For instance, when the system determines something about the road appears unusual (e.g., abnormal sensed condition or event) and/or determines a possible driving characteristic may be present in the sensor data, but with confidence below a configured threshold confidence value/level, human-in-the loop intervention or review can be used. The system can automatically generate or trigger a request for one or more human labelers to view and analyze the underlying sensor data about which the ML road intelligence engine has reached an uncertain conclusion. The human labelers can provide an input (e.g., real-time label or labeling) indicative of the ground truth represented by the sensor data in question. In some cases, the human-in-the-loop labelers can confirm or reject the ML road intelligence engine's automatically generated prediction or conclusion. In some cases, the human-in-the-loop labelers can provide a ground truth label for the sensor data, which is then ingested to the road intelligence engine as an additional data point for generating an updated or refined prediction for the characteristics or events represented in the underlying sensor data that triggered the human labeler review request.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The processes described herein can include a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the processes described herein, may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

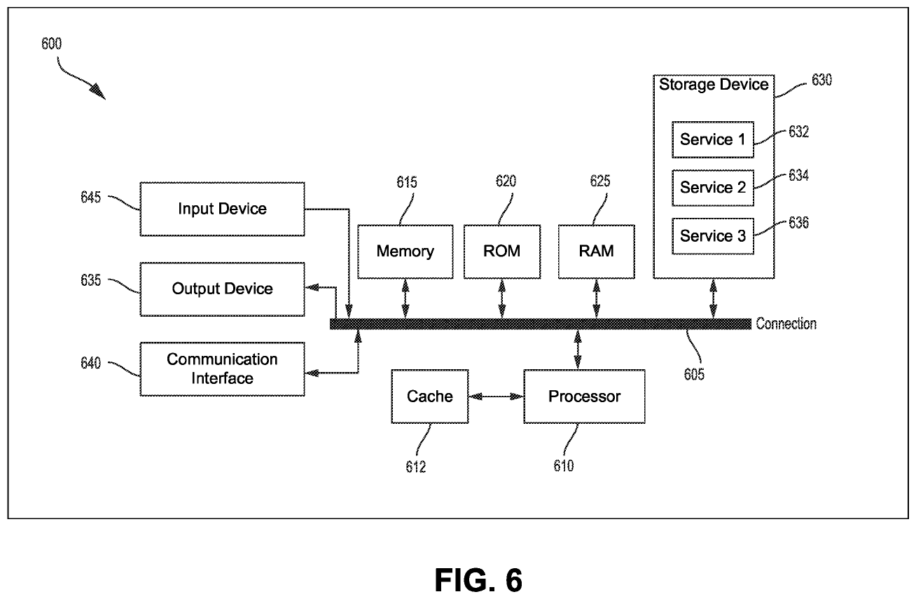

FIG. 6 is a diagram illustrating an example of a system for implementing certain aspects of the present technology. In particular, FIG. 6 illustrates an example of computing system 600, which may be for example any computing device making up internal computing system, a remote computing system, a camera, or any component thereof in which the components of the system are in communication with each other using connection 605. Connection 605 may be a physical connection using a bus, or a direct connection into processor 610, such as in a chipset architecture. Connection 605 may also be a virtual connection, networked connection, or logical connection.

In some aspects, computing system 600 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 600 includes at least one processing unit (CPU or processor) 610 and connection 605 that communicatively couples various system components including system memory 615, such as read-only memory (ROM) 620 and random-access memory (RAM) 625 to processor 610. Computing system 600 may include a cache 612 of high-speed memory connected directly with, in close proximity to, or integrated as part of processor 610.

Processor 610 may include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which may represent any number of input mechanisms, such as a microphone for speech, a touch-sensitive screen for gesture or graphical input, keyboard, mouse, motion input, speech, etc. Computing system 600 may also include output device 635, which may be one or more of a number of output mechanisms. In some instances, multimodal systems may enable a user to provide multiple types of input/output to communicate with computing system 600.

Computing system 600 may include communications interface 640, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 630 may include software services, servers, services, etc., that when the code that defines such software is executed by the processor 610, it causes the system to perform a function. In some aspects, a hardware service that performs a particular function may include the software component stored in a computer-readable medium in connection with the necessary hardware components, such as processor 610, connection 605, output device 635, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general-purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random-access memory (RAM) such as synchronous dynamic random-access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one”and “one or more”are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. A method comprising: obtaining sensor data associated with one or more field of view (FOV) coverage areas of a roadway environment, wherein the sensor data includes respective sensor streams obtained from a plurality of distributed sensors deployed on roadside infrastructure within the roadway environment, each sensor of the plurality of distributed sensors corresponding to a particular one of the one or more FOV coverage areas; transmitting at least a portion of the sensor data to a vehicle traffic analysis engine, wherein the vehicle traffic analysis engine is configured to identify sensor data obtained from different sensors and different FOV coverage areas as corresponding to a same first vehicle; analyzing, by the vehicle traffic analysis engine, the identified sensor data to determine one or more driving characteristics of the first vehicle within the roadway environment; and transmitting, to the first vehicle, automatically generated driver assistance information, wherein the automatically generated driver assistance information is configured to remediate erratic driving characteristics included in the determined one or more driving characteristics of the first vehicle.

Aspect 2. The method of Aspect 1, wherein the determined one or more driving characteristics of the first vehicle are based on analyzing the identified sensor data against one or more traffic safety rules.

Aspect 3. The method of Aspect 1, further comprising identifying the erratic driving characteristics as a deviation from a baseline of expected driving characteristics observed by the vehicle traffic analysis engine for historic vehicle traffic within the one or more FOV coverage areas of the roadway environment.

Aspect 4. The method of Aspect 1, wherein the automatically generated driver assistance information comprises control or configuration information generated for an Advanced Driver Assistance Systems (ADAS) control module of the first vehicle.

Aspect 5. The method of Aspect 4, wherein the control or configuration information corresponds to a configured ADAS level for the first vehicle.

Aspect 6. The method of Aspect 1, wherein the automatically generated driver assistance information comprises a notification message to an infotainment system or onboard display of the first vehicle.

Aspect 7. The method of Aspect 6, wherein the notification message comprises an ADAS level 0 control or configuration information.

Aspect 8. The method of Aspect 1, further comprising: analyzing the obtained sensor data using one or more trained machine learning networks, wherein the one or more trained machine learning networks generate as output one or more detected objects of interest and movement information associated with the one or more detected objects of interest; and based on analyzing the obtained sensor data, automatically generating one or more autonomous vehicle control commands.

Aspect 9. The method of Aspect 8, wherein the detected objects of interest include one or more of a vehicle, a pedestrian, and a moving object located in the roadway environment.

Aspect 10. The method of Aspect 8, wherein the one or more autonomous vehicle control commands are transmitted to a receiver coupled to a control system of a vehicle located within the FOV coverage area of the roadway environment.

Aspect 11. The method of Aspect 10, wherein the one or more autonomous vehicle control commands are configured to halt movement of the vehicle in response to determining that movement information associated with the vehicle violates one or more pre-determined traffic rules.

Aspect 12. The method of Aspect 10, wherein the one or more autonomous vehicle control commands are configured to autonomously navigate the vehicle within the FOV coverage area by automatically controlling acceleration and steering of the vehicle.

Aspect 13. The method of Aspect 1, wherein the sensor data is obtained from one or more overhead sensor system modules installed on a light pole, traffic light, or other infrastructure element located above the roadway environment.

Aspect 14. The method of Aspect 13, wherein the FOV coverage area corresponds to an FOV of a single overhead sensor system module.

Aspect 15. The method of Aspect 13, wherein the FOV coverage area is a combined FOV generated using a respective FOV associated with each overhead sensor system module of a plurality of overhead sensor system modules.

Aspect 16. An apparatus comprising: at least one memory; and at least one processor coupled to the at least one memory, the at least one processor configured to: obtain sensor data associated with one or more field of view (FOV) coverage areas of a roadway environment, wherein the sensor data includes respective sensor streams obtained from a plurality of distributed sensors deployed on roadside infrastructure within the roadway environment, each sensor of the plurality of distributed sensors corresponding to a particular one of the one or more FOV coverage areas; transmit at least a portion of the sensor data to a vehicle traffic analysis engine, wherein the vehicle traffic analysis engine is configured to identify sensor data obtained from different sensors and different FOV coverage areas as corresponding to a same first vehicle; analyze, by the vehicle traffic analysis engine, the identified sensor data to determine one or more driving characteristics of the first vehicle within the roadway environment; and transmit, to the first vehicle, automatically generated driver assistance information, wherein the automatically generated driver assistance information is configured to remediate erratic driving characteristics included in the determined one or more driving characteristics of the first vehicle.

Aspect 17. The apparatus of Aspect 16, wherein, to determine the determined one or more driving characteristics of the first vehicle, the at least one processor is configured to analyze the identified sensor data against one or more traffic safety rules.

Aspect 18. The apparatus of Aspect 16, wherein the at least one processor is further configured to identify the erratic driving characteristics as a deviation from a baseline of expected driving characteristics observed by the vehicle traffic analysis engine for historic vehicle traffic within the one or more FOV coverage areas of the roadway environment.

Aspect 19. The apparatus of Aspect 16, wherein the automatically generated driver assistance information comprises control or configuration information generated for an Advanced Driver Assistance Systems (ADAS) control module of the first vehicle.

Aspect 20. The apparatus of Aspect 16, wherein the control or configuration information corresponds to a configured ADAS level for the first vehicle.

Aspect 21. The apparatus of Aspect 16, wherein the automatically generated driver assistance information comprises a notification message to an infotainment system or onboard display of the first vehicle.

Aspect 22. The apparatus of Aspect 21, wherein the notification message comprises an ADAS level 0 control or configuration information.

Aspect 23. The apparatus of Aspect 16, wherein the at least one processor is further configured to: analyze the obtained sensor data using one or more trained machine learning networks, wherein the one or more trained machine learning networks generate as output one or more detected objects of interest and movement information associated with the one or more detected objects of interest; and based on analyzing the obtained sensor data, automatically generate one or more autonomous vehicle control commands.

Aspect 24. The apparatus of Aspect 23, wherein the detected objects of interest include one or more of a vehicle, a pedestrian, and a moving object located in the roadway environment.

Aspect 25. The apparatus of Aspect 23, wherein the one or more autonomous vehicle control commands are transmitted to a receiver coupled to a control system of a vehicle located within the FOV coverage area of the roadway environment.

Aspect 26. The apparatus of Aspect 25, wherein the one or more autonomous vehicle control commands are configured to halt movement of the vehicle in response to determining that movement information associated with the vehicle violates one or more pre-determined traffic rules.

Aspect 27. The apparatus of Aspect 25, wherein the one or more autonomous vehicle control commands are configured to autonomously navigate the vehicle within the FOV coverage area by automatically controlling acceleration and steering of the vehicle.

Aspect 28. The apparatus of Aspect 16, wherein the sensor data is obtained from one or more overhead sensor system modules installed on a light pole, traffic light, or other infrastructure element located above the roadway environment.

Aspect 29. The apparatus of Aspect 28, wherein the FOV coverage area corresponds to an FOV of a single overhead sensor system module.

Aspect 30. The apparatus of Aspect 28, wherein the FOV coverage area is a combined FOV generated using a respective FOV associated with each overhead sensor system module of a plurality of overhead sensor system modules.

What is claimed is:

1. A method comprising:
obtaining sensor data associated with one or more field of view (FOV) coverage areas of a roadway environment, wherein the sensor data includes respective sensor streams obtained from a plurality of distributed sensors deployed on roadside infrastructure within the roadway environment, each sensor of the plurality of distributed sensors corresponding to a particular one of the one or more FOV coverage areas;
transmitting at least a portion of the sensor data to a vehicle traffic analysis engine, wherein the vehicle traffic analysis engine is configured to identify sensor data obtained from different sensors and different FOV coverage areas as corresponding to a same first vehicle;
analyzing, by the vehicle traffic analysis engine, the identified sensor data to determine one or more driving characteristics of the first vehicle within the roadway environment; and
transmitting, to the first vehicle, automatically generated driver assistance information, wherein the automatically generated driver assistance information is configured to remediate erratic driving characteristics included in the determined one or more driving characteristics of the first vehicle.

2. The method of claim 1, wherein the determined one or more driving characteristics of the first vehicle are based on analyzing the identified sensor data against one or more traffic safety rules.

3. The method of claim 1, further comprising identifying the erratic driving characteristics as a deviation from a baseline of expected driving characteristics observed by the vehicle traffic analysis engine for historic vehicle traffic within the one or more FOV coverage areas of the roadway environment.

4. The method of claim 1, wherein the automatically generated driver assistance information comprises control or configuration information generated for an Advanced Driver Assistance Systems (ADAS) control module of the first vehicle.

5. The method of claim 4, wherein the control or configuration information corresponds to a configured ADAS level for the first vehicle.

6. The method of claim 1, wherein the automatically generated driver assistance information comprises a notification message to an infotainment system or onboard display of the first vehicle.

7. The method of claim 6, wherein the notification message comprises an ADAS level 0 control or configuration information.

8. The method of claim 1, further comprising:
analyzing the obtained sensor data using one or more trained machine learning networks, wherein the one or more trained machine learning networks generate as output one or more detected objects of interest and movement information associated with the one or more detected objects of interest; and
based on analyzing the obtained sensor data, automatically generating one or more autonomous vehicle control commands.

9. The method of claim 8, wherein the detected objects of interest include one or more of a vehicle, a pedestrian, and a moving object located in the roadway environment.

10. The method of claim 8, wherein the one or more autonomous vehicle control commands are transmitted to a receiver coupled to a control system of a vehicle located within the FOV coverage area of the roadway environment.

11. The method of claim 10, wherein the one or more autonomous vehicle control commands are configured to halt movement of the vehicle in response to determining that movement information associated with the vehicle violates one or more pre-determined traffic rules.

12. The method of claim 10, wherein the one or more autonomous vehicle control commands are configured to autonomously navigate the vehicle within the FOV coverage area by automatically controlling acceleration and steering of the vehicle.

13. The method of claim 1, wherein the sensor data is obtained from one or more overhead sensor system modules installed on a light pole, traffic light, or other infrastructure element located above the roadway environment.

14. The method of claim 13, wherein the FOV coverage area corresponds to an FOV of a single overhead sensor system module.

15. The method of claim 13, wherein the FOV coverage area is a combined FOV generated using a respective FOV associated with each overhead sensor system module of a plurality of overhead sensor system modules.

16. An apparatus comprising:
at least one memory; and
at least one processor coupled to the at least one memory, the at least one processor configured to:
obtain sensor data associated with one or more field of view (FOV) coverage areas of a roadway environment, wherein the sensor data includes respective sensor streams obtained from a plurality of distributed sensors deployed on roadside infrastructure within the roadway environment, each sensor of the plurality of distributed sensors corresponding to a particular one of the one or more FOV coverage areas;
transmit at least a portion of the sensor data to a vehicle traffic analysis engine, wherein the vehicle traffic analysis engine is configured to identify sensor data obtained from different sensors and different FOV coverage areas as corresponding to a same first vehicle;
analyze, by the vehicle traffic analysis engine, the identified sensor data to determine one or more driving characteristics of the first vehicle within the roadway environment; and
transmit, to the first vehicle, automatically generated driver assistance information, wherein the automatically generated driver assistance information is configured to remediate erratic driving characteristics included in the determined one or more driving characteristics of the first vehicle.

17. The apparatus of claim 16, wherein, to determine the determined one or more driving characteristics of the first vehicle, the at least one processor is configured to analyze the identified sensor data against one or more traffic safety rules.

18. The apparatus of claim 16, wherein the at least one processor is further configured to identify the erratic driving characteristics as a deviation from a baseline of expected driving characteristics observed by the vehicle traffic analysis engine for historic vehicle traffic within the one or more FOV coverage areas of the roadway environment.

19. The apparatus of claim 16, wherein the automatically generated driver assistance information comprises control or configuration information generated for an Advanced Driver Assistance Systems (ADAS) control module of the first vehicle.

20. The apparatus of claim 16, wherein the control or configuration information corresponds to a configured ADAS level for the first vehicle.
